(19) United States
(12) Patent Application Publication
(10) Pub. No.: US 2013/0091187 A1
(43) Pub. Date: Apr. 11, 2013

(54) STORAGE DEVICE

(71) Applicant: Yuki Yamanokoshi, Aichi (JP)

(72) Inventor: Yuki Yamanokoshi, Aichi (JP)

(73) Assignee: ADC Technology Inc., Nagoya-shi (JP)

(21) Appl. No.: 13/642,819

(22) PCT Filed: Apr. 21, 2011
(86) PCT No.: PCT/JP2011/059816

§ 371 Date: Dec. 10, 2012

(30) Foreign Application Priority Data
Apr. 22, 2010 (JP) 2010-098970

(51) Int. Cl. G06F 17/30

(52) U.S. Cl. CPC G06F 17/30091
USPC 707/821

(57) ABSTRACT

A storage device includes: a connecting terminal that communicates data with a another device; a first storing device that is able to store a still image file received from the another device via the connecting terminal; a second storing device that stores a synthetic data file used when synthesizing a predetermined information to a still image; and a control device that executes data process. The data process is a process in which a synthesized still image file is created that is able to identify a still image, in which the predetermined information based upon the synthetic data file stored in the second storing device is synthesized to a portion of the still image displayed by the still image file, and the synthesized still image file is stored in the first storing device, when the still image file is stored in the first storing device.

### CROSS-REFERENCE TO RELATED APPLICATIONS

This international application claims the benefit of Japanese Patent Application No. 2010-098970 filed Apr. 22, 2010 in the Japan Patent Office, the entire disclosures of which are incorporated herein by reference.

### TECHNICAL FIELD

The present invention relates to a storage device for storing files created by image-capturing with use of a digital camera or a digital video camera.

### BACKGROUND ART

Patent Document 1 describes a digital camera which advertises by inserting an advertisement over a portion of a picture taken and by displaying the advertisement on a display unit. The advertisement can reach a number of people by distributing this type of digital camera for free or at a low price.

Patent Document 2 discloses a technology to output wirelessly, to an external device, information regarding a memory card having a wireless function (specifically, attachment/detachment status of the memory card to an information processor, status of the power source of the information processor attached with the memory card, or the remaining amount of power of a power source which the memory card has).

### Prior Art Documents

### Patent Literature

Patent Document 1: JP2008526166A

Patent Document 2: JP2002366919A

### SUMMARY OF THE INVENTION

### Problems to be Solved by the Invention

(1) First Object

In the digital camera described in Patent Document 1, advertisement overlaps a picture taken and is displayed only on the display unit. For example, when an image file of the picture taken is loaded in a PC and is displayed on a screen of the PC, the displayed picture has not been inserted with the advertisement. Further, when the image file of the picture taken is printed out in a print medium via a printer, the printed out picture has not been inserted with the advertisement. That is, the digital camera described in Patent Document 1 has a problem that advertisement can not reach all the people who sees the picture after having taken the picture.

The first object of the subject invention is to provide a storage device which is able to convey advertising to more people by use of files, which have been created by digital cameras, digital video cameras, and the like, as advertising media.

(2) Second Object

Regarding the memory card disclosed in Patent Document 2, the above mentioned information regarding the memory card is outputted to an external device wirelessly, which therefore requires a wireless setting appropriate for the memory card. In general, the wireless setting of the memory card is performed on a PC using a setting application exclusive to the subject memory card in a state where the memory card has been connected to the PC. However, this type of setting application is usually an exclusive item for each memory card, and a setting screen and a setting procedure are hence different depending on the type of setting application. In addition, if there is no PC at hand, which has been installed with the setting application, it is not possible to confirm the wireless setting status (ID, password, encryption type, and the like). Therefore, when an event occurs where the above described information regarding the memory card can not be outputted to the external device, even if the wireless setting is suspected to be a cause thereof, the wireless setting status can not be confirmed so easily.

The second object of the present invention is therefore to provide a storage device, which is a memory card etc. having a wireless function, and a user of which can easily confirm a wireless setting status.

(3) Third Object

It has been widely known that a detachable and compact storage device is used as a storage medium of a digital camera and so on. When this type of storage device is used as a storage medium of a digital camera and so on, still image files and/or moving image files are stored in order of shooting in the storage device. Therefore, it is necessary to use a PC or the like to classify the files in accordance with the shooting location or the shooting object after the shooting. In some of digital cameras, folders to store the files can be designated before the shooting. However, shooting has to be performed considering the object of the use of the folders, so that these digital cameras are not easy to use.

The third object of the present invention is therefore to provide a storage device which is convenient for users to classify files (especially still image files).

(4) Fourth Object

A storage device, such as a memory card and so on having a file uploading function via wireless communication, has been known. In this type of storage device, if the storage device is inserted into a digital camera and is loaded with still image files and/or moving image files from the digital camera, the loaded files are transmitted to a server or a PC via wireless communication. Further, since a memory area of the storage device is limited, a storage device has been known, which has a function of deleting already transmitted files when a certain amount of memory usage is exceeded. However, if the files are deleted as described above, even if the storage device is connected to a PC or the like after the deleting, it is not possible to confirm, from the storage device, what kind of files had been exist. Therefore, users are likely to forget the presence of the deleted files that has been already transmitted to a server, a PC or the like, and the files are likely not to be used effectively.

The fourth object of the present invention is therefore to provide a storage device that can inhibit the files from not being used effectively because users forget presence of the files, while ensuring an unused memory area of the storage device as much as possible.

### Means for Solving the Problems

A storage device according to a first aspect of the present invention in order to solve the first object includes: a connecting terminal that communicates data with a another device; a first storing device that is able to store a still image file received from the another device via the connecting terminal; a second storing device that stores a synthetic data file used when synthesizing a predetermined information to a still image; and a control device that executes a data process. This data process is a process that, when the still image file is stored in the first storing device, creates a synthesized still image file that is able to display a still image, in which the predetermined information based upon the synthetic data file stored in the second storing device is synthesized to a portion of a still image displayed by the still image file, and stores the synthesized still image file in the first storing device. The predetermined information may be any information as long as it is information related to advertisement. It is preferable that the predetermined information is, for example, a wording or image recalling a product, a service, a corporation, a brand or the like (specifically, a product name, a service name, a corporation name, a brand name, a product image, a service mark, a corporation mark, a brand mark, and so on), or inquiry information (a URL, a search key word, a telephone number, and so on). The predetermined information hereinafter is the same as mentioned above. Further, the first storing device and the second storing device may be achieved either by a single hardware or separate hardwares (hereinafter, same as above).

According to this type of storage device, the predetermined information is synthesized to a picture image captured, for example, by a digital camera, so as to be stored as a synthesized still image file in the first storing device. Accordingly, if the file stored in the storage device is read out and utilized, an advertisement can be displayed with the picture image not only in the digital camera used for the shooting but also in a variety of display media such as a PC, a digital photo frame, or a printed paper. That is, the use of the storage device enables advertisement accessible to more people.

There is a possibility that digital camera users may want to avoid inserting of the advertisement to the picture captured. On the assumption of this type of situation, the following constitution is conceivable.

The control device may be constructed so as not to execute the data process in a case where a time elapsed after the immediately last storing of a different still image file in the first storing device is within a predetermined period of time even if the still image file is stored in the first storing device (the storage device according to a second aspect of the present invention).

The followings are appropriate as the predetermined period of time for example: about a shooting interval (e.g., about one second) by a continuous-shooting mode of a digital camera as the another device and about a shooting interval (e.g., about one minute) for capturing the same object by a digital camera again. However, the predetermined period of time may be arbitrarily determined depending on types of another device possibly used, possible users, types of predetermined information to be synthesized, or the like.

According to this type of storage device, for example, in a case where a plurality of still image files are continuously written in the storage device within the predetermined period of time, regarding a still image file loaded first, a synthesized still image file synthesized with the predetermined information is created and stored, but, regarding a still image file loaded secondly or after, a synthesized still image file is not created. That is, the users can avoid synthesizing intentionally by controlling a timing to write a still image file, which leads to a user-friendly storage device.

When a still image file is a picture of a human face, if the predetermined information is synthesized so as to overlap the face, there is a possibility that the person in the picture can not be identified. Therefore, when the still image file stored in the first storing device is a file able to display an image containing a human face, it is preferable that the control device synthesizes the predetermined information at a location other than the human face in the data process (a storage device according to a third aspect of the present invention).

According to this type of storage device, it is possible to avoid creating a synthesized still image file of a still image in which the predetermined information overlaps a human face.

When a plurality of different synthetic data files have been stored in the second storing device, the control device selects the synthetic data file from the second storing device based upon a shooting location of the still image displayed by the still image file stored in the first storing device and executes the data process using the synthetic data file selected (the storage device according to a fourth aspect of the present invention).

According to this type of storage device, a synthesized still image file is created, which is for a still image synthesized with information corresponding to a shooting location of the still image file. Therefore, advertising effect can be especially enhanced if the predetermined information to be synthesized is an advertisement associated with a location.

A storage device may be constructed as described below so as to solve the first object. That is, a storage device may include: a connecting terminal that communicates data with a another device; a first storing device that is able to store a moving image file received from the another device via the connecting terminal; a second storing device that stores a synthetic data file used when synthesizing a predetermined information to a moving image; and a control device that executes a data process. As this data process, it is preferable that, when the moving image file is stored in the first storing device, the control device performs a process in which a synthesized moving image file is created that is able to display a moving image, in which the predetermined information based upon the synthetic data file stored in the second storing device is synthesized to a portion of a frame forming a moving image displayed by the moving image file, and the synthesized moving image file is stored in the first storing device (a storage device according to a fifth aspect of the present invention).

According to this type of storage device, the predetermined information is synthesized to a moving image captured, for example, by a digital video camera or the like, and it is stored as a synthesized moving image file in the first storing device. Accordingly, if the storage device is utilized, an advertisement can be displayed with the moving image not only in the digital video camera used for the shooting but also in various display media such as a PC that can play the moving image, a digital photo frame that can play the moving image, and so on. That is, the use of the storage device enables advertisement accessible to more people.

The synthetic data file may be stored in the second storing device at the time of manufacturing, shipping, or selling the storage device. The storage device may further include: a synthetic data file obtaining device that obtains the synthetic data file from the another device; and a synthetic data file storing control device that replaces the synthetic data file stored in the second storing device with the synthetic data file obtained from the another device via the synthetic data file obtaining device and stores the synthetic data file obtained from the another device via the synthetic data file obtaining device (a storage device according to a sixth aspect of the present invention).

According to this type of storage device, the synthetic data file can be updated even after the storage device is delivered to the users, so that old advertisement can be inhibited from being synthesized as much as possible and an advertising effect is enhanced.

A storage device may be constituted as described below so as to solve the first object. That is, a storage device may include: a connecting terminal that communicates data with a another device; a first storing device that is able to store a moving image file received from the another device via the connecting terminal; a second storing device that stores a combining moving image file used when combining a predetermined moving image to a different moving image; and a control device that executes a data process. When the moving image file is stored in the first storing device, the control device may perform a process as this data process in which a combined moving image file is created that is able to display a moving image, in which the predetermined moving image based upon the combining moving image file stored in the second storing device is combined to a moving image displayed by the moving image file, and the combined moving image file is stored in the first storing device. (a storage device according to a seventh aspect of the present invention).

According to this type of storage device, the predetermined moving image is combined to a moving image captured, for example, by a digital video camera or the like, so as to be stored as a combined moving image file in the first storing device. Accordingly, if the storage device is utilized, an advertisement can be displayed with the moving image not only in the digital video camera used for the shooting but also in various display media such as a PC that can play the moving image, a digital photo frame that can play the moving image, or the like. That is, the use of the storage device enables advertisement accessible to more people.

The combining moving image file may be stored in the second storing device at the time of manufacturing, shipping, or selling the storage device. The storage device may further include: a combining moving image file obtaining device that obtains the combining moving image file from the another device; and a combining moving image file storing control device that replaces the combining moving image file stored in the second storing device with the combining moving image file obtained from the another device via the combining moving image file obtaining device and stores the combining moving image file obtained from the another device via the combining moving image file obtaining device (a storage device according to an eighth aspect of the present invention).

According to this type of storage device, the combining moving image file can be updated even after the storage device has been delivered to the users, so that old advertisement moving image can be inhibited from being combined as much as possible and an advertising effect is enhanced.

Especially, it is preferable that, in the data process, the control device defines a file name of the file created by the data process as the file name of the file associated with the data process and having been stored in the first storing device prior to the start of the data process, and the control device changes the file name of the file associated with the data process and having been stored in the first storing device prior to the start of the data process to a different file name (a storage device according to a ninth aspect of the present invention).

According to this type of storage device, the file before being applied with the data process is stored separately. The users can obtain the file before being applied with the data process when the file is needed for some reason, which enhances usability of the storage device.

A storage device may be constituted as described below so as to solve the first object. That is, a storage device may include: a connecting terminal that communicates data with a another device; a first storing device that is able to store a still image file received from the another device via the connecting terminal; a second storing device that stores an additional still image file able to display a still image containing a predetermined information; and a control device that executes a data process. It is preferable that the control device performs a process, as the data process, where the additional still image file stored in the second storing device is stored in the first storing device when the predetermined number of still image files is stored in the first storing device (a storage device according to a tenth aspect of the present invention).

According to this type of storage device, when picture images captured for example by a digital camera or the like are stored as the still image files at a predetermined amount, an additional still image file, which can display a still image containing a predetermined information, is stored in the first storing device additionally. Accordingly, if the storage device is utilized, the additional still image file can be displayed not only on the digital camera used for the image capturing but also on various display media, such as a PC, a digital photo frame, a printed paper, or the like. That is, the use of the storage device enables advertisement accessible to more people.

It is preferable that the plurality of still image files received in order from the another device via the connecting terminal includes file names containing numbers not overlapping each other respectively. When the numbers are ascending sequence, the control device may store, in the first storing device, the additional still image file with a file name having a number portion incremented by one from the number portion of a file name of a still image file received last among the predetermined number of still image files and stored in storing device (a storage device according to an eleventh aspect of the present invention).

According to this type of storage device, when the files stored in the first storing device are arranged in ascending order, the additional still image files are arranged between the still image files received from the another device. Accordingly, advertising effects are enhanced when users see the files in order of file name and so on.

The additional still image file may be stored in the second storing device at the time of manufacturing, shipping, or selling the storage device. The storage device may further include: an additional still image file obtaining device that is able to obtain the additional still image file from the another device; and an additional still image file storing control device that replaces the additional still image file stored in the second storing device with the additional still image file obtained from the another device via the additional still image file obtaining device so that the additional still image file obtained from the another device via the additional still image file obtaining device is stored (a storage device according to a twelfth aspect of the present invention).

According to this type of storage device, the additional still image file can be updated even after the storage device has been delivered to the users, so that the additional still image file for old advertisement can be inhibited from being added as much as possible, so that an advertising effect can be enhanced.

Further, it is considered that some users of the storage device do not wish the data process to be performed. Accordingly, it is preferable that, when a predetermined cancel condition is satisfied, the control device no longer executes the data process thereafter (a storage device according to a thirteenth aspect of the present invention)

According to the storage device having this type of control device, it is prepared for the users who do not wish the data process to be executed and it can motivate the users to act so as to satisfy the cancel condition.

More specifically, it is preferable that the cancel condition is a condition that the number of times to have performed the data process reaches a predetermined number of times (a storage device according to a fourteenth aspect of the present invention).

Further, it is preferable that another cancel condition is a condition that the still image file sent from the another device and stored contains a predetermined determination image. That is, when the still image file that can display the still image is written in the first storing device, the control device may perform a determination process to determine whether or not the still image file displays an image containing the predetermined determination image. The control device may determine that the cancel condition is satisfied when an affirmative determination is obtained at the determination process (a storage device according to a fifteenth aspect of the present invention).

When this type of cancel condition is set, the storage device can be used as a storage device that does not perform the data process after the cancel condition is satisfied. Therefore, it is possible to encourage more users to use the storage device before canceling, which increases the opportunity to execute the data process and enhances advertising effects.

Also, it is preferable that each of the synthetic data file, the combining moving image file, and the additional still image file includes, at at least a part, a URL to access an website where the determination image can be seen (storage devices according to sixteenth, seventeenth, and eighteenth aspects of the present invention).

In this case, it is possible to guide the users of the storage device to the website and to advertise on the website, thereby enabling to enhance advertising effects.

Further, in particular, it is preferable that the another device is a device provided with an imaging element, image information obtained from the imaging element is stored as a file in the first storing device, and the storage device is connected to the another device via a connecting terminal and is arranged with the another device in the same housing (a storage device according to a nineteenth aspect of the present invention). The aforementioned storage device can further enhance each effect described above.

The connecting terminal may be a wireless interface that communicates data with the another device via wireless communication (a storage device according to a twentieth aspect of the present invention). The aforementioned storage device can exhibit the same effects described above.

A storage device according to a twenty-first aspect of the present invention in order to solve the above described second object includes: a connecting terminal that communicates data with a another device; a first storing device that is able to store a file received from the another device via the connecting terminal and is able to read the file stored and output the file to the another device via the connecting terminal; a wireless communicating device that is able to transmit the file stored in the first storing device to an outside via wireless communication; a second storing device that stores wireless setting information needed when the wireless communicating device performs the wireless communication; and an information outputting device that stores, in the first storing device as a still image file, the wireless setting information stored in the second storing device.

According to this type of storage device, even in a case where the wireless communication can not be performed for some reasons, such as that the setting of the wireless communicating device does not fit the current wireless environment, it is possible to confirm the wireless setting information by opening the still image file stored in the first storing device. That is, users can confirm the wireless setting information more easily compared to before.

A storage device according to a twenty-second aspect of the present invention in order to solve the third object described above includes: a connecting terminal that communicates data with a another device; a first storing device that is able to store a still image file received from the another device via the connecting terminal; and a control device that performs a classifying process to classify the still image file stored in the first storing device based upon a predetermined feature of the still image file.

According to this type of storage device, the still image file is classified in the storage device based upon the predetermined feature of the still image file. Therefore, when there is nothing wrong with the classification from the user's view, there is no need for the user to classify at all. Meanwhile, when ₜhe classification is partially not correct from the user's view, the user may classify only the incorrect file manually at PC and so on. Therefore, usability is dramatically enhanced compared to before.

Here, it is preferable that the predetermined feature of the still image file is at least any one of the presence or absence of a specific object included in a still image, a shooting time and date of the still image file, and a shooting location of the still image file. That is, it is preferable that the control device performs the classifying process based upon at least any one of these (a storage device according to a twenty-third aspect of the present invention). Here, a human is, for example, conceivable as the specific object.

According to this type of storage device, even if users do not confirm the above mentioned elements (the presence or absence of the specific object included in the still image, the shooting time and date, and the shooting location) of each still image file, each still image file is classified inside the storage device. Therefore, when users consider that it is appropriate to classify based upon the above-mentioned element, usability is dramatically enhanced compared to before.

Further, any performance of the classification may be appropriate, but it is preferable to perform the classification by moving each of the still image files to each folder for each classification (a storage device according to a twenty-fourth aspect of the present invention).

By classifying as described above, it is possible to read out still image files belonging to a specific classification in a lump and in a unit of folder, which is user friendly. Further, regarding the outcome of the performed classification, a method of performing the classification is conceivable, by which a common letter string is prepended to each file name of each still image file belonging to the predetermined classification. Also in this case, it is possible to easily select and in a lump the still image files belonging to the specific classification by sorting the list of the file names, which is user friendly.

In addition, it is preferable that the control device further performs a listing process, in which a list of the still image file classified based upon the classifying process is created and stored in the first storing device, the list being a list in which identifying information is arranged by each classification, and the identifying information being able to identify the still image file (a storage device according to a twenty-fifth aspect of the present invention).

According to the storage device having this type of control device, users can confirm easily still image files belonging to each classification by using to the list.

Further, a storage device according to a twenty-sixth aspect of the present invention in order to solve the fourth object described above includes: a connecting terminal that communicates data with a first another device; a first storing device that is able to store a file received from the first another device via the connecting terminal and is able to read the file stored and output the file to the first another device via the connecting terminal; a wireless communicating device that is able to transmit the file stored in the first storing device to a second another device other than the first another device via wireless communication; a control device that performs a first process of transmitting the file stored in the first storing device to the second another device via the wireless communicating device, a second process of storing file identifying information in the first storing device, the file identifying information being information which consumes a storage area smaller than a storage area consumed by the file in the first storing device and can identify the file, and a third process of deleting, from the first storing device, the file having been completed with the first and second processes.

According to this type of storage device, even after deleting the file received from the first another device and stored in the first storing device, the file identifying information on the deleted file remains in the first storing device. Therefore, when a user connects the storage device to a device such as a PC etc. later, the user can confirm, with the file identifying information as a clue on the device, what kind of file had been present. Accordingly, it is possible to inhibit users from forgetting presence of the files and to inhibit the files from not being used effectively as much as possible.

Further, in order to further inhibit users from forgetting the presence of the files, especially when the file stored in the first storing device is a still image file, the control device, in the second process, creates a thumbnail image of a still image displayed by the still image file and stores the thumbnail image as the file identifying information in the first storing device (a storage device according to a twenty-seventh aspect of the present invention).

According to this type of storage device, when a user connect the storage device to a device such as a PC etc. later, the user can confirm, on the device, the thumbnail image of the still image file already deleted, so that the user can confirm the contents of the still image file intuitively. Therefore, it is possible to further inhibit the still image files from not being used effectively, caused by the user forgetting the presence of the file.

Further, it is preferable that, in the second process, the control device stores a URL, where a computer can obtain the file via internet, as the file identifying information in the first storing device (a storage device according to a twenty-eighth aspect of the present invention).

According to this type of storage device, when a user connects the storage device to a device such as PC etc. later, the user can obtain easily the file by use of the URL, so that the file can be used more effectively.

Further, the above described functions as the control device may be implemented by a program (a program according to a twenty-ninth aspect of the present invention). By making a computer provided in the storage device execute this type of program, the storage device can achieve the same functions and effects as the storage devices described above. Further, the program can be distributed by use of a network etc., and replacement of the program in the storage device is easier compared with replacements of parts. Therefore, it is possible to improve easily the function of the storage device.

### BRIEF DESCRIPTION OF THE DRAWINGS

FIG. 1 is a block diagram showing a structure of a storage device.

FIG. 2 is a flowchart illustrating a first file writing process.

FIG. 3 is a flowchart illustrating a first cancel condition determining process.

FIG. 4 is a flowchart illustrating a second cancel condition determining process.

FIG. 5 is an example of an additional still image file including an URL to access a website where a predetermined image for determination can be browsed.

FIG. 6 is a flowchart illustrating a first still image handling process.

FIGS. 7A through 7C are examples of still images to explain synthesizing of advertising information with still images.

FIG. 8 is a flowchart illustrating a second still image handling process.

FIG. 9 is a flowchart for illustrating a first moving image handling process.

FIG. 10 is a flowchart for illustrating a second moving image handling process.

FIGS. 11A and 11B are examples of flames to explain combining of advertising information with a moving image.

FIG. 12 is a flowchart for illustrating a wireless communication information output process.

FIG. 13 is an example of a wireless information image.

FIG. 14 is a flowchart for illustrating a second file writing process.

FIG. 15 is an example of a stored-file list. FIG. 16 is a flowchart for illustrating a file uploading process.

FIG. 17 is an example for explaining a content of an upload file list.

FIG. 18 is a block diagram illustrating a structure of a digital camera.

### EXPLANATION OF REFERENCE NUMERALS

10, 30 . . . storage device, 11 . . . main flash memory,

12 . . . memory controller, 13 . . . battery,

14, 22 . . . CPU, 15, 35 . . . sub flash memory,

16, 23 . . . RAM, 17 . . . wireless LAN controller,

18 . . . antenna, 19 . . . connecting terminal,

20 . . . another device, 21 . . . digital camera,

24 . . . operation unit, 25 . . . imaging element,

26 . . . shutter, 27 . . . lens actuator

### Mode for Carrying Out the Invention

Hereinafter, embodiments of the present invention will be described with reference to drawings. The embodiment of the present invention should not be limited to the embodiments set forth below and can take various forms within the technical scope of the present invention.

### FIRST EMBODIMENT

A first embodiment will be described.

[Description of the Structure]

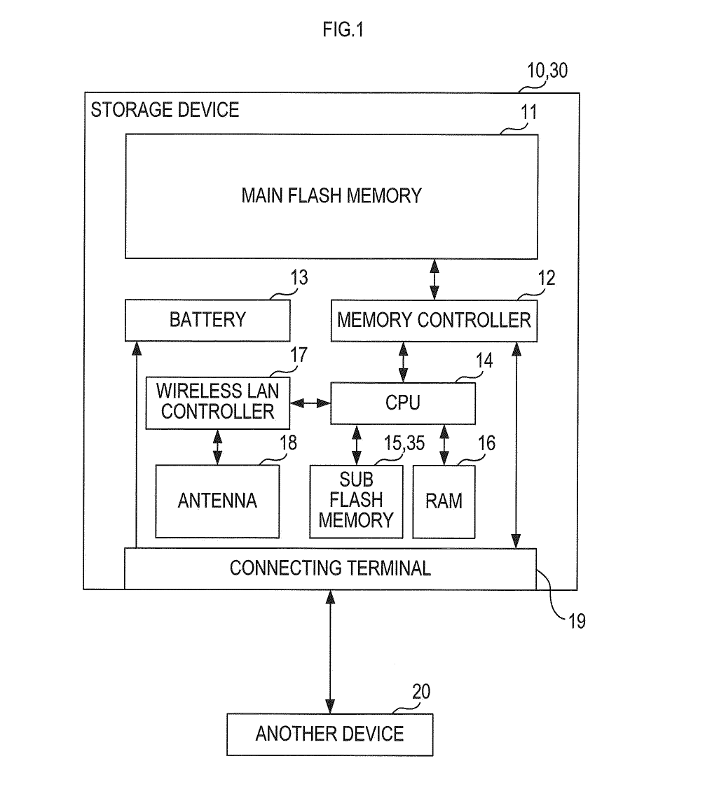

A structure of a storage device 10 according to the first embodiment will be described with reference to FIG. 1. The storage device 10 is provided with a main flash memory 11, a memory controller 12, a battery 13, a CPU 14, a sub flash memory 15, a RAM 16, a wireless LAN controller 17, an antenna 18, and a connecting terminal 19. A housing of the storage device 10 has a card-shaped appearance (for example, a shape similar to a SD card). The storage device 10 is configured so as to be inserted into a not-illustrated slot of a another device 20 and to be able to be connected to a not-illustrated connecting terminal provided at the slot. However, the shape of the housing of the storage device 10 is not limited to the card shape. For example, the storage device 10 may be a stick shape such as a commonly-used USB memory device.

The main flash memory 11 is a flash memory that is a type of non-volatile readable and writable memory and is able to store a plurality of still image files, moving image files, and the like. As far as the main flash memory 11 is a non-volatile readable and writable memory, it should not be limited to a flash memory.

The memory controller 12 is a controller that controls an access to the main flash memory 11, and allows data to be written to, to be read from, and to be deleted in, the main flash memory 11, in accordance with a command that the memory controller 12 receives.

The battery 13 is a chargeable and dischargeable battery, such as a lithium-ion rechargeable battery or the like. Although it is not illustrated, the battery 13 is connected to each portion of the storage device 10. Further, when the storage device 10 is inserted into a slot of the another device 20 and is connected thereto, an electric power supply from the another device 20 via the connecting terminal 19 is initiated, and the battery 13 is charged until an amount of electric power of the battery 13 reaches a predetermined amount. When the storage device 10 is removed from the slot of the another device 20 and the electric power supply from the another device 20 is discontinued, the battery 13 initiates supplying electric power to each portion of the storage device 10. This electric power supply continues for a set amount of time (e.g., for fifteen minutes), thereby enabling each portion of the storage device 10 to function. That is, even if the electric power supply is discontinued, various processes described later will be able to be executed for the set amount of time.

The CPU 14 is a module having an arithmetic processing function and loads programs stored in the sub flash memory 15 to the RAM 16, so that various processes are executed. The CPU 14 also has a function as a memory controller for the sub flash memory 15 and the RAM 16.

The sub flash memory 15 is a flash memory that is a type of a non-volatile readable and writable memory and can store synthetic data files and so on (described later) as well as programs executed by the CPU 14. As long as the sub flash memory 15 is a non-volatile readable and writable memory, it should not be limited to a flash memory.

The RAM 16 is configured with a DRAM etc., which is a type of non-volatile readable and writable memory and is used as a temporary memory area when the CPU 14 executes various process.

The wireless LAN controller 17 is a controller for implementing a wireless LAN function such as IEEE802.11n etc. and can communicate with external devices (e.g., PC, servers on internet, and so on) via the antenna 18. Instead of the wireless LAN controller 17, any controllers may be used, such as Bluetooth standard controllers, controllers that can establish an access to a cell phone packet communication network, WiMAX standard controllers, and so on, regardless of whether it is LAN or WAN.

The antenna 18 is an antenna for a wireless LAN and is connected to the wireless LAN controller 17. When the wireless LAN controller 17 is replaced by a controller having a different communication function, it is preferable that the antenna is changed accordingly.

The connecting terminal 19 is a contact-type terminal and is configured with a terminal for receiving electric power supplied by the another device 20 and a terminal for exchanging data with the another device 20, etc. The storage device 10 according to the present embodiment has a contact-type terminal (for example, a terminal of a SD card, a terminal of a USB memory device, or the like), but it may be a non-contact-type communication interface. The non-contact-type communication interface may be, for example, Felica (registered trademark), NFC (Near Field Communication), etc.

The another device 20 is a device having a connecting terminal corresponding to the above-described connecting terminal 19, and various types of information processing units are conceivable as the another device 20, such as a personal computer (PC), a digital camera, a digital video camera, a cell phone, and so on.

[Description of Operation]

The various processes executed by the storage device 10 will be described. Known processes will be omitted, such as a reading-out process for reading out files stored in the storage device 10 based upon the instructions from the another device 20 and sending to the another device 20, a clearing process for clearing the files stored in the storage device 10 based upon the instructions from the another device 20, and so on.

(1) First File Writing Process

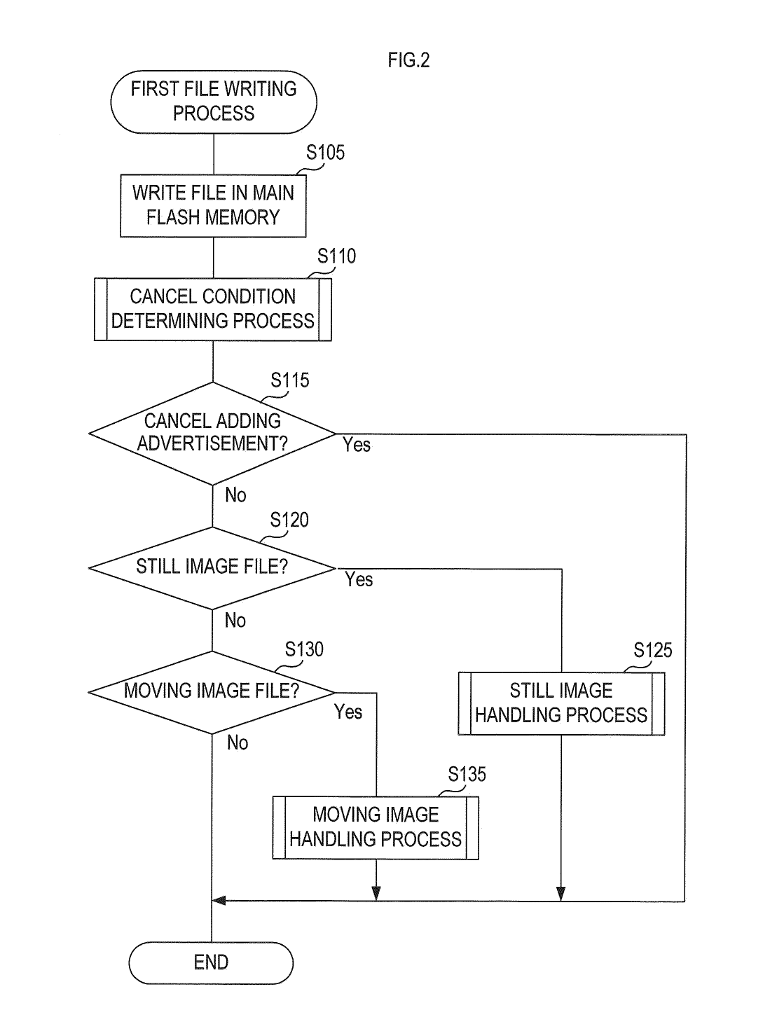

The first file writing process will be described with reference to the flowchart in FIG. 2. The execution of this first file writing process is initiated when the storage device 10 receives, from the another device 20, a signal denoting that a file is sent from the another device 20, in a state where the connecting terminal 19 of the storage device 10 is connected to the connecting terminal provided at the slot of the another device 20. The execution of the first file writing process is initiated corresponding to each file transmitted from the another device 20. That is, when a plurality of files are transmitted from the another device 20, the executions of the first file writing process are initiated by the number of the file transmissions.

When the CPU 14 of the storage device 10 receives a signal denoting that a file is sent from the another device 20, the CPU 14 of the storage device 10 instructs the memory controller 12 so as to write the file sent from the another device 20 in the main flash memory 11 (S105). The memory controller 12, which has received the instructions, writes sequentially, in a free space of the main flash memory 11, data of the files sent from the another device 20 via the connecting terminal 19. When a data denoting the end of the subject file is sent from the another device 20, the memory controller 12 returns to the CPU 14 that the writing of the file has completed.

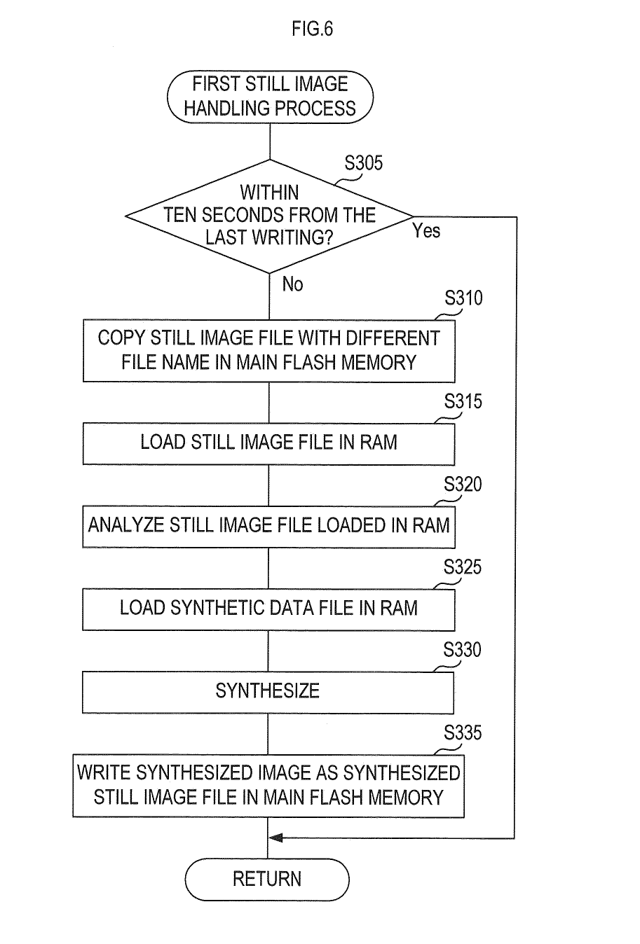

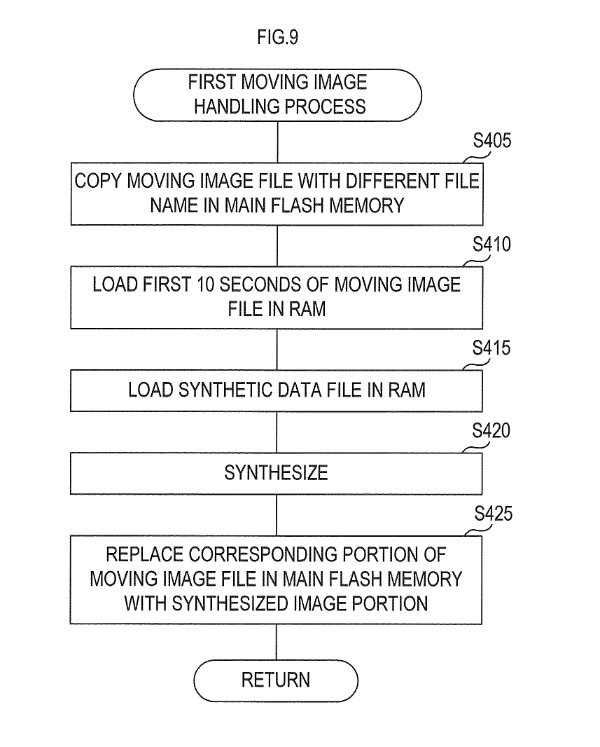

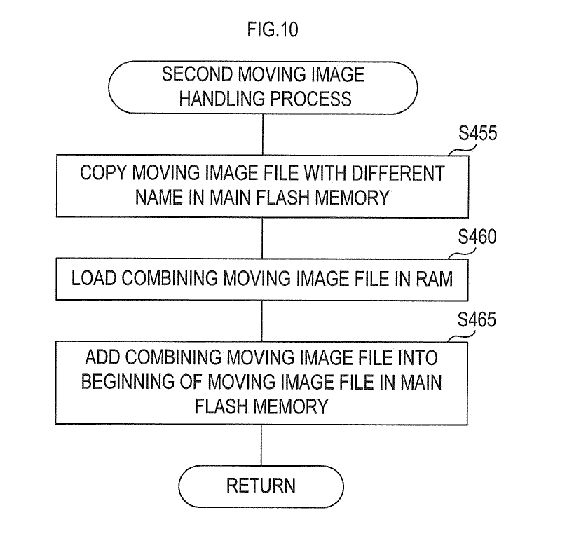

Following that, the CPU 14 executes a cancel condition determining process (S110). Although this cancel condition determining process will be described later, it is a process to determine whether or not a still image handling process (S125, FIG. 6, FIG. 8) and a moving image handling process (S135, FIG. 9, FIG. 10) are to be executed (to be cancelled).

Following that, the CPU 14 determines whether or not to cancel addition of advertisement (S115). This determination is implemented based upon the result (return value) of the cancel condition determining process at S110. When the result of the cancel condition determining process is a result that the advertisement addition is to be cancelled (the cancel condition is satisfied) (S115: Yes), the process (the first file writing process) is terminated. Meanwhile, when the result of the cancel condition determining process is a result that the advertisement addition is not to be cancelled (the cancel condition is not satisfied) (S115: No), the process proceeds to S120.

When the process proceeds to S120, the CPU 14 determines whether or not the file written in the main flash memory 11 at S105 is a still image file. As a determining method, determination based upon an extension of the file, determination by allowing the RAM 16 to read a part of the file, such as a header, and so on are conceivable, but the determining method is not limited to the above.

When the determination result at S120 is affirmative (S120: Yes), the CPU 14 proceeds with the process to S125 and a still image handling process is executed. Meanwhile, when the determination result at 8120 is negative (S120: No), the CPU 14 proceeds with the process to S130. At S130, determination is made as to whether or not the file written in the main flash memory 11 at S105 is a moving image file. As a determining method, determination based upon an extension of the file, determination by allowing the RAM 16 to read a part of the file, such as a header, and so on are conceivable, but the determining method is not limited to the above.

When the determination result at S130 is affirmative (S130: Yes), the CPU 14 proceeds with the process to S135 and a moving image handling process is executed. When the determination result at S130 is negative (S130: No), the CPU 14 terminates the subject process (first file writing process).

The CPU 14 terminates the subject process (first file writing process) also when the still image handling process at S125 or the moving image handling process at S135 is ended.

(2) First Cancel Condition Determining Process

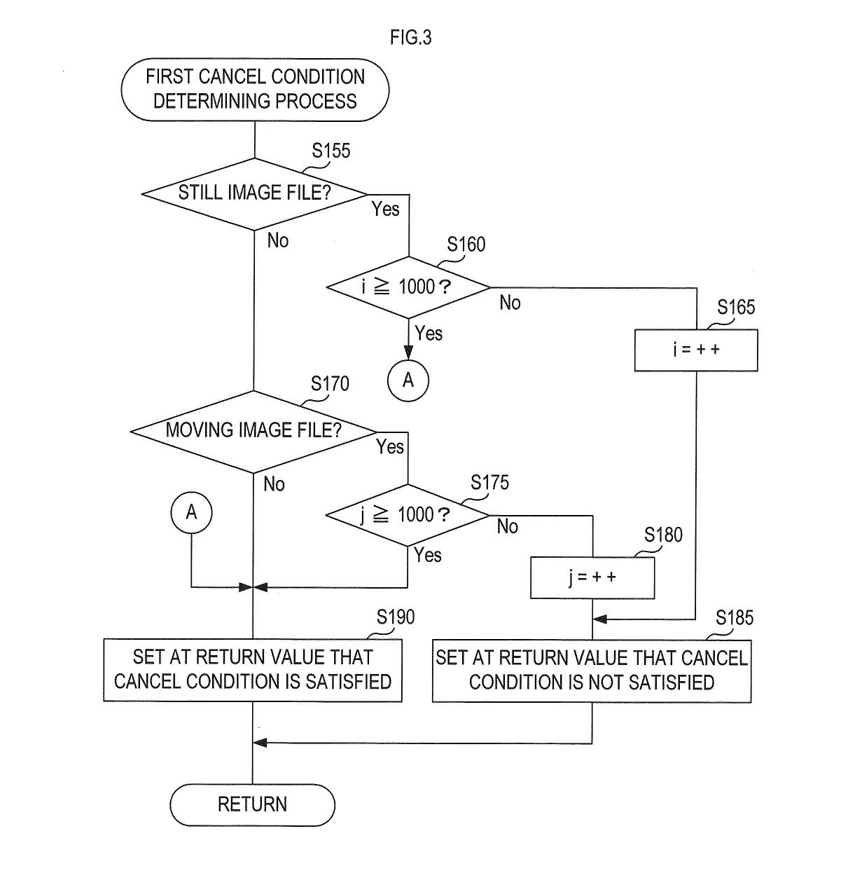

Next, the first cancel condition determining process will be described with reference to the flowchart in FIG. 3. This first cancel condition determining process is a process which is called at S110 of the first file writing process described above and of which execution is initiated. Further, as a storage device 10 of other embodiment, a second cancel condition determining process described later may be executed instead of the first cancel condition determining process.

When the CPU 14 initiates the execution of the first cancel condition determining process, the CPU 14 first determines whether or not the file written in the main flash memory 11 at S105 of the first file writing process described above is a still image file (S155). As a determining method, determination based upon an extension of the file, determination by allowing the RAM 16 to read a part of the file, such as a header, and so on are conceivable, but the determining method is not limited to the above.

When the determination result at S155 is affirmative, i.e., when the file written in the main flash memory 11 is a still image file (S155: Yes), the CPU 14 proceeds with the process to S160. Meanwhile, when the determination result at S155 is negative, i.e., when the file written in the main flash memory 11 is not a still image file (S155: No), the process proceeds to S170.

At S160 to which the process proceeds when the determination result at S155 is affirmative, determination is made as to whether or not a value of a variable i is 1000 or more, This variable i is a variable (counter) stored in the sub flash memory 15 and indicates the frequency of initiation of the execution of the still image handling process described later. This variable i is assigned a value of “0” at the time of manufacturing (or shipping) the storage device 10, and even when power supply to the storage device 10 is discontinued, the value is preserved.

When the determination result at S160 is affirmative, i.e., when the value of the variable i is 1000 or more (S160: Yes), the CPU 14 proceeds with the process to S190. When the determination result at S160 is negative, i.e., when the value of the variable i is not 1000 or more (S160: No), the process proceeds to S165.

At S165 to which the process proceeds when the

CPU 14 determines that the value of the variable i is not 1000 or more, the value of the variable i is increased by one and is stored in the sub flash memory 15. The CPU 14 proceeds with the process to S185.

At S170 to which the process proceeds when the determination result at S155 is negative, i.e., when the CPU 14 determines that the file written in the main flash memory 11 is not a still image file, the CPU 14 determines whether or not the file written in the main flash memory 11 at S105 of the first file writing process described above is a moving image file (S170). As a determining method, determination based upon an extension of the file, determination by allowing the RAM 16 to read a part of the file, such as a header, and so on is conceivable, but the determining method is not limited to the above.

When the determination result at S170 is affirmative, i.e. when the file written in the main flash memory 11 is a moving image file (S170: Yes), the CPU 14 proceeds with the process to S175. Meanwhile, when the determination result at S170 is negative, i.e. when the file written in the main flash memory 11 is not a moving image file (S170: No), the CPU 14 proceeds with the process to S190.

At S175 to which the process proceeds when the determination result at S170 is affirmative, i.e., when the file written in the main flash memory 11 is a moving image file, the CPU 14 determines whether or not a value of a variable j is 1000 or more. This variable j is a variable (counter) stored in the sub flash memory 15 and indicates the frequency of initiation of the execution of the moving image handling process described later. This variable j is assigned a value of “0” at the time of manufacturing (or shipping) the storage device 10, and even when power supply to the storage device 10 is discontinued, the value is preserved.

When the determination result at S175 is affirmative, i.e., when the value of the variable j is 1000 or more (S175: Yes), the CPU 14 proceeds with the process to S190. Meanwhile, when the determination result at S175 is negative, i.e., when the value of the variable j is not 1000 or more (S175: No), the CPU 14 proceeds with the process to S180.

At S180 to which the process proceeds when the determination is made that the value of the variable j is not 1000 or more, the CPU 14 increases the value of the variable j by one and stores the value in the sub flash memory 15. The CPU 14 proceeds with the process to S185.

At S185, the CPU 14 sets, at the return value, that the cancel condition is not satisfied, terminates the subject process (first file writing process), and executes the process that follows S110 of the first file writing process that invokes the first cancel condition determining process.

At S190, the CPU 14 sets, at the return value, that the cancel condition is satisfied, terminates the subject process(first file writing process), and executes the process that follows S110 of the first file writing process that invokes the first cancel condition determining process.

(3) Second Cancel Condition Determining Process

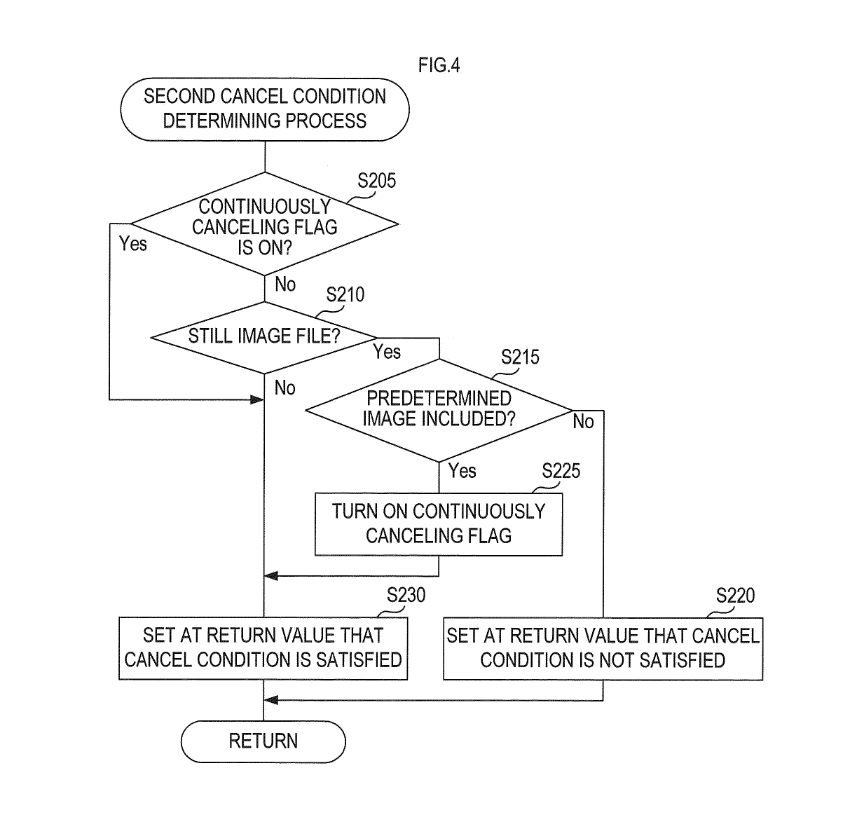

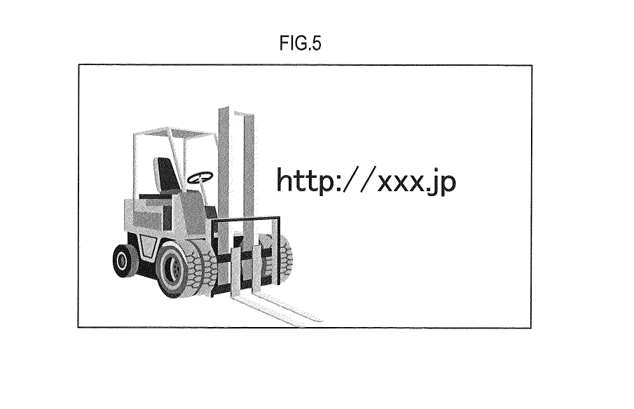

Next, the second cancel condition determining process will be described with reference to the flowchart in FIG. 4. This second cancel condition determining process is a process executed, instead of the first cancel condition determining process, by a storage device 10 of other embodiment other than the storage device 10 which executes the above-described first cancel condition determining process. In analogy with the above-described first cancel condition determining process, the second cancel condition determining process is a process which is called at S110 of the above-described first file writing process and of which execution is initiated. At the sub flash memory 15 of the storage device 10 to execute the second cancel condition determining process, an additional still image file, a synthetic data file, and a combining data file are stored; the additional still image file includes a URL to access an website where a predetermined image for determination described for explaining S215 below can be browsed (see FIG. 5 for an example of an additional still image file). As a result of performing the after-mentioned still image handling process (S125, FIG. 6, FIG. 8) and the after-mentioned moving image handling process (S135, FIG. 9, FIG. 10), this URL can catch users' attention.

When the CPU 14 initiates the execution of the second cancel condition determining process, the CPU 14 first determines whether or not a continuously canceling flag is in an on state (S205). This continuously canceling flag is flag information stored in the sub flash memory 15 and is a flag that indicates whether or not to continuously unexecute an addition of an advertisement (the addition of the advertisement includes executing the still image handling process (S125, FIG. 6, FIG. 8) and the moving image handling process (S135, FIG. 9, FIG. 10)). This continuously canceling flag is assigned a value of “Off” (the value means execution) at the time of manufacturing (or shipping) the storage device 10, and even when power supply to the storage device 10 is discontinued, the value is preserved.

When the determination result at S205 is affirmative, i.e., when the continuously canceling flag is ON (S205: Yes), the CPU 14 proceeds with the process to S230. Meanwhile, when the determination result at S205 is negative, i.e., when the continuously canceling flag is not ON (S205: No), the CPU 14 proceeds with the process to S210.

At S210 to which the process proceeds when the continuously canceling flag is not ON, i.e., when the continuously canceling flag is OFF, determination is made as to whether or not the file written in the main flash memory 11 at S105 of the above-described first file writing process is a still image file (S210). As the determining method, determination based upon an extension of the file, and determination by allowing the RAM 16 to read a part of the file, such as a header, and so on are conceivable, but the determining method is not limited to the above.

When the determination result at S210 is affirmative, i.e., when the file written in the main flash memory 11 is a still image file (S210: Yes), the CPU 14 proceeds with the process to S215. Meanwhile, when the determination result at S210 is negative, i.e., when the file written in the main flash memory 11 is not a still image file (S210: No), the CPU 14 proceeds with the process to S230.

At S215 to which the process proceeds when determination is made that the file written in the main flash memory 11 is a still image file, determination is made as to whether or not a predetermined image for determination is included in a portion of a still image displayed by the still image file. As the predetermined image for determination, a wording recalling a product, a service, a corporation, a brand or the like (specifically, a product name, a service name, a corporation name, a brand name or the like), its image (specifically, a product image, a service mark, a corporation mark, a brand mark, or the like), or a bar code or two-dimensional code having coded information, for example, are conceivable.

When the determination result at S215 is affirmative, i.e., when the predetermined image is included in the portion of the still image file (S215: Yes), the CPU 14 proceeds with the process to S225. Meanwhile, when the determination result at S215 is negative, i.e., when the predetermined image is not included in the portion of the still image file (S215: No), the CPU 14 proceeds with the process to S220.

At S225 to which the process proceeds when determination is made that the predetermined image is included in the portion of the still image file file, the CPU 14 changes the continuously canceling flag to ON and allows the sub flash memory 15 to store. The CPU 14 then proceeds with the process to S230.

At S230, the CPU 14 sets, at the return value, that the cancel condition is satisfied, terminates the subject process (the first file writing process) and executes the process that follows S110 of the first file writing process that invokes the second cancel condition determining process.

At S220, the CPU 14 sets, at the return value, that the cancel condition is not satisfied, terminates the subject process(first file writing process), and executes the process that follows S110 of the first file writing process that invokes the second cancel condition determining process.

(4) First Still Image Handling Process

Next, the first still image handling process will be described with reference to the flowchart in FIG. 6. This first still image handling process is a process which is called at S125 of the above-described first file writing process and of which execution is initiated. Further, as a storage device 10 of other embodiment, a second still image handling process described later may be executed instead of the first still image handling process.

When the CPU 14 initiates the execution of the first still image handling process, the CPU 14 first determines whether or not the file writing in the main flash memory 11 executed at S105 of the above-described first file writing process was implemented within ten seconds after the writing of a different file implemented immediately before (S305). In other words, the CPU 14 determines the presence, or the absence, of the writing of a different file from the another device 20 to the storage device 10 within the past ten seconds. Therefore, for example, if there are the continuous writings of a plurality of still image files in the storage device 10 by the another device 20 at an interval of a few seconds or less, an affirmative determination is made at the subject step. Although a time of ten seconds is employed here, any time period may be employed as long as the time period to be employed is sufficient to determine the presence of continuous image capturings and so on. The time period may be determined arbitrarily based upon various conditions.

When the determination result at S305 is affirmative, i.e., when the file written in the main flash memory 11 was written within ten seconds from the immediately last writing of a file (S305: Yes), the CPU 14 terminates the subject process (first still image handling process), and executes a process that follows S125 of the first file writing process that invokes the first still image handling process.

When the determination result at S305 is negative, i.e., when the file written in the main flash memory 11 was not written within ten seconds after the file written immediately before, the CPU 14 proceeds with the process to S310.

The CPU 14, which has proceeded with the process to S310, assigns the file written in the main flash memory 11 with a different name and copies (writes) the file into a hidden folder of the main flash memory 11. As a different file name, any name can be here employed. For example, it is preferable to prepend a letter string, such as “org” indicating that the file is an original file, to the file name.

The CPU 14 then allows the RAM 16 to load the still image file written in the main flash memory 11 at S105 of the above-described first file writing process (S315). This step may be performed at the same time as the copy at S310 described above.

The CPU 14 then analyzes the still image file loaded into the RAM 16 (S320). As analyzing mentioned here, the following is included, for example: (a) determination is made as to whether or not a human face is included in the still image based upon the still image file; (b) if the human face is included in the still image, identification is made as to at which location in the still image the human face is included; (c) if the human face is included in the still image, identification is made as to who the human included in the still image is, with reference to data on human feature pre-stored in the sub flash memory 15 or data on human feature stored in an external database that is connectable via the wireless LAN controller 17; (d) identification is made as to what an object included in the still image based upon the still image file is (for example, a mountain, a bridge, an ocean, an automobile, a train, an airplane, a ship, furniture, an animal, or the like); and (e) identification of a shooting location of the still image based upon the still image file is made with reference to geotags included in the still image file.

The CPU 14 then selects, based upon the analyzing result at S320, one out of a plurality of synthetic data files pre-stored in the sub flash memory 15, and allows the RAM 16 to read the one selected (S325). The synthetic data file mentioned here is an image file or a text file to synthesize advertising information to the still image based upon the still image file written in the main flash memory 11. As the advertising information, a wording recalling a product, a service, a corporation, a brand or the like (specifically, a product name, a service name, a corporation name, a brand name or the like), its image (specifically, a product image, a service mark, a corporation mark, a brand mark, or the like), inquiry information (an URL, a search key word, a telephone number, or the like) and special information for users (for example, discount information, gift information, discount/free coupon information) are conceivable, for example. Regarding selecting of the synthetic data file, for example, if furniture is included in the still image based upon the still image file, a synthetic data file which displays an advertisement regarding furniture is selected out of the plurality of synthetic data files stored in the sub flash memory 15. If the shooting location of the still image is Tokyo, a synthetic data file which displays an advertisement regarding Tokyo is selected out of the plurality of synthetic data files stored in the sub flash memory 15.

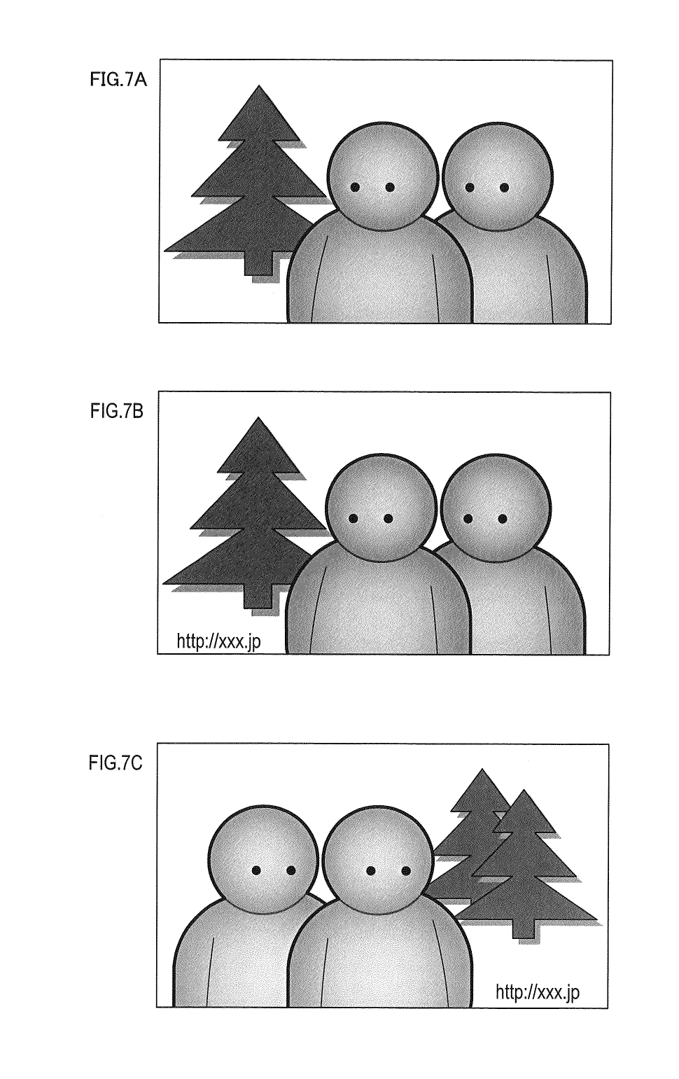

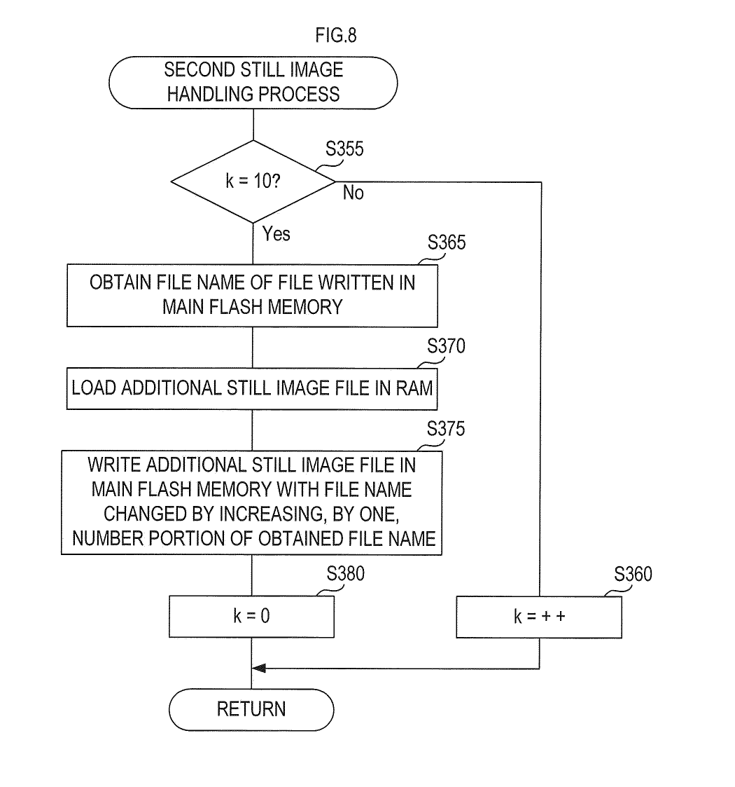

The CPU 14 then synthesizes the advertising information based upon the synthetic data file loaded to the RAM 16 to the still image based upon the still image file loaded to the RAM 16 at S315, so that a synthesized still image is created (S330). At this point, it is preferable that the location of advertising information to be synthesized in the still image is selected based upon the analyzing result at S320 and the advertising information is synthesized. For example, if there is a human face shown in the still image, a URL is synthesized at a location other than the face (or the whole human body). A specific example will be described with reference to FIGS. 7A through 7C.

FIG. 7A is a still image showing two people therein and is a still image before being synthesized with an advertising information. FIG. 7B is a still image after synthesizing a URL, which is advertising information, at a location not overlapping the two people, i.e., at the lower left portion of the still image. FIG. 7C is a different example of a still image after synthesizing a URL, which is advertising information, at a location not overlapping the two people, i.e., at the lower right portion of the still image.

The explanation goes back to the flowchart in FIG. 6, and the CPU 14 then writes, in the main flash memory 11, a synthesized still image file which is able to display the synthesized still image created at S330 (S335). The file name at the time of this writing is written with the file name of the file written in the main flash memory 11 at S105 of the first file writing process.

The CPU 14 then terminates the subject process (the first still image handling process) and executes the process that follows S125 of the first file writing process that invokes the first still image handling process.

(5) Second Still Image Handling Process

Next, the second still image handling process will be described with reference to the flowchart in FIG. 8. This second still image handling process is a process executed, instead of the first still image handling process, by a storage device 10 of other embodiment other than the storage device 10 which executes the above-described first still image handling process. In analogy with the above-described first still image handling process, the second still image handling process is a process which is called at S125 of the first file writing process and of which execution is initiated.

When the execution of the second still image handling process is initiated, the CPU 14 firstly determines whether or not a value of a variable k is ten (10). This variable k is a variable (counter) stored in the sub flash memory 15 and is used to determine whether each step from S365 to S380 described below is to be executed or whether S360 is to be executed. This variable k is assigned a value of “0” at the time of manufacturing (or shipping) the storage device 10 and, even when power supply to the storage device 10 is discontinued, the value is preserved.

When the determination result at S355 is affirmative, i.e., when the value of the variable k is ten (S355: Yes), the CPU 14 proceeds with the process to S360. When the determination result at S355 is negative, i.e., when the value of the variable k is not ten (S355: No), the CPU 14 proceeds with the process to S365.

At S360 to which the process proceeds when determination is made that the value of the variable k is ten, the CPU 14 increases the value of the variable k only by one and stores the variable k in the sub flash memory 15. The CPU 14 terminates the subject process (second still image handling process), and executes the process that follows S125 of the first file writing process that invokes the second still image handling process.

At S365 to which the process proceeds when the determination result at S355 is negative, i.e., determination is made that the value of the variable k is not ten, the CPU 14 obtains the file name of the file written in the main flash memory 11 at S105 of the first file writing process that invokes the subject process (second still image handling process).

The CPU 14 then allows the RAM 16 to load an additional still image file from the sub flash memory 15 (S370). The additional still image file mentioned here is a still image file containing advertising information therein. As the advertising information, a wording recalling a product, a service, a corporation, a brand or the like (specifically, a product name, a service name, a corporation name, a brand name or the like), its image (specifically, a product image, a service mark, a corporation mark, a brand mark, or the like), inquiry information (a URL, a search key word, a telephone number, or the like) and special information for users (for example, discount information, gift information, discount/free coupon information) are conceivable. Further, a plurality of additional still image files may be stored in the sub flash memory 15, an additional still image file may be selected corresponding to an object contained in the still image based upon the still image file written to the main flash memory 11 at S105 of the above-described first file writing process, and the additional still image file selected may be loaded from the sub flash memory 15 to the RAM 16. For example, in a case where furniture is included in the still image based upon the still image file written to the main flash memory 11, an additional still image file for displaying an advertisement related to furniture may be selected from among the plurality of additional still image files stored in the sub flash memory 15 and may be loaded to the RAM 16. Further, in a case where a shooting location of the still image is Tokyo, an additional still image file for displaying an advertisement related to Tokyo may be selected from among the plurality of additional still image files stored in the sub flash memory 15 and may be loaded to the RAM 16.

The CPU 14 then writes the additional still image file in the main flash memory 11 with a file name changed by increasing, by one, the number portion of the file name obtained at S365 (S375). For example, when the file name obtained at S365 is “DSC11633.jpg”, the additional still image file is written in the main flash memory 11 assigned with the file name “DSC11634.jpg”. It is assumed that this process is executed when the still image files received from the another device 20 are assigned respectively with the file names containing the numbers not duplicated among each other, and the numbers are in ascending sequence.

The CPU 14 then sets the value of the variable k at zero and stores the value in the sub flash memory 15 (S380). The CPU 14 terminates the subject process (second still image handling process), and executes the process that follows S125 of the first file writing process that invokes the second still image handling process.

(6) First Moving Image Handling Process

Next, the first moving image handling process will be described with reference to the flowchart in FIG. 9. This first moving image handling process is a process that is called at S135 of the above-described first file writing process, and of which execution is initiated. Further, as a storage device 10 of other embodiment, a second moving image handling process may be executed instead of the first moving image handling process.

When the execution of the first moving image handling process is initiated, the CPU 14 copies, into a hidden folder of the main flash memory 11 with a different name, a moving image file written to the main flash memory 11 at S105 of the first file writing process (S405). As a different name mentioned here, any name can be applied. For example, it is favorable to prepend a letter string, such as “org” indicating that the file is an original file, to the file name.

The CPU 14 then allows the RAM 16 to load a partial data corresponding to the first ten seconds after the start of the moving image based upon the moving image file written to the main flash memory 11 at the above-described S105 of the above-described first file writing process (S410).

The CPU 14 then allows the RAM 16 to load a synthetic data file stored pre-stored in the sub flash memory 15 (S415). The synthetic data file mentioned here is an image file or a text file to synthesize advertising information to the moving image based upon the moving image file written in the main flash memory 11. As the advertising information, a wording recalling a product, a service, a corporation, a brand or the like (specifically, a product name, a service name, a corporation name, a brand name or the like), its image (specifically, a product image, a service mark, a corporation mark, a brand mark, or the like), inquiry information (URL, search key word, telephone number, or the like) and special information for users (for example, discount information, gift information, discount/free coupon information) are conceivable, for example.

The CPU 14 then creates a synthesized moving image by synthesizing advertising information based upon the synthetic data file loaded to the RAM 16 with the moving image based upon the partial data loaded to the RAM 16 at S410 and corresponding to the first ten seconds after the start (S420). Further, it is considered that the CPU 14 synthesizes the advertising information, for example, at the lower right or lower left portion of a frame forming the moving image continuously for ten seconds. As a result, when the moving image file is played, the advertising information is synthesized and displayed for the first ten seconds after the start of the moving image.

The CPU 14 replaces data of a corresponding portion of the corresponding moving image file stored in the main flash memory 11 with a synthesized moving image data that can display the synthesized moving image created at S420 (S425).

The CPU 14 then terminates the subject process (first moving image handling process), and executes the process that follows S135 of the first file writing process that invokes the first moving image handling process.

(7) Second Moving Image Handling Process

Next, the second moving image handling process will be described with reference to the flowchart in FIG. 10. This second moving image handling process is a process executed instead of the first moving image handling process by a storage device 10 of other embodiment other than the storage device 10 which executes the above-described first moving image handling process. In analogy with the above-described first moving image handling process, the second moving image handling process is a process which is called at S135 of the above-described first file writing process, and of which execution is initiated.

When the execution of the second moving image handling process is initiated, the CPU 14 first copies, into a hidden folder of the main flash memory 11 with a different name, a moving image file written to the main flash memory 11 at S105 of the first file writing process (S455). As a different name mentioned here, any name may be employed. For example, it is preferable to prepend a letter string, such as “org” indicating that the file is an original file, to the file name.

The CPU 14 then allows the RAM 16 to load a combining moving image file stored pre-stored in the sub flash memory 15 (S460). The combining moving image file mentioned here is a moving image file to combine a moving image having advertising information to a moving image based upon the moving image file written in the main flash memory 11. As the advertising information, for example, a wording recalling a product, a service, a corporation, a brand or the like (specifically, a product name, a service name, a corporation name, a brand name or the like), its image (specifically, a product image, a service mark, a corporation mark, a brand mark, or the like), an image to advertise them, a voice to advertise them, an image conveying special information for users (for example, discount information, gift information, discount/free coupon information), and the like are conceivable.

The CPU 14 then add in, to the beginning portion of the moving image file stored in the main flash memory at S105 of the above-described first file writing process, the combining moving image file loaded to the RAM 16 at S460 (S425). At a time of adding, it is needless to say to modify data of a header portion that manages moving image information of the moving image file.

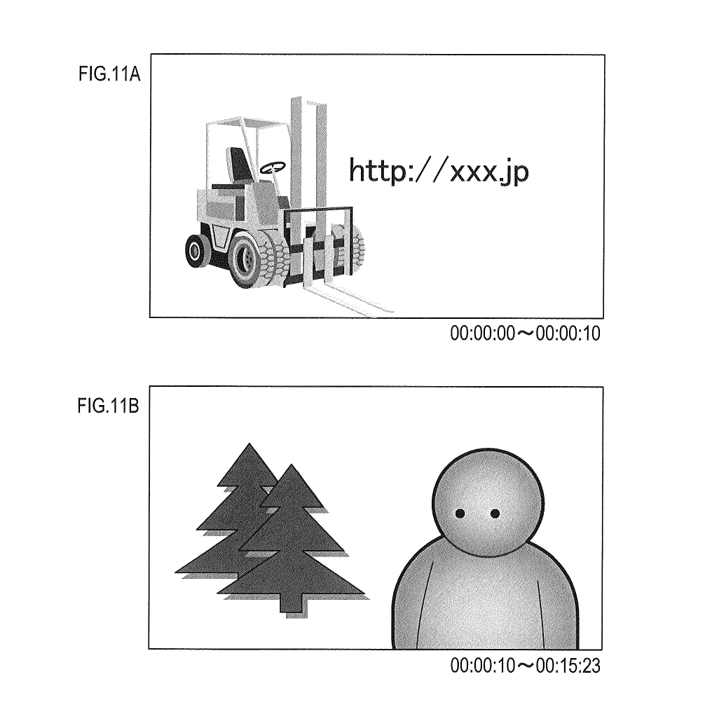

When the moving image file added as described above is played, the moving image based upon the combining moving image file is first played for ten seconds (e.g., see FIG. 11A), and the original moving image is then played (e.g., see FIG. 11B).

The CPU 14 then terminates the subject process (second moving image handling process), and executes the process that follows S135 of the first file writing process that invokes the second moving image handling process.

(8) Wireless Communication Information Output Process

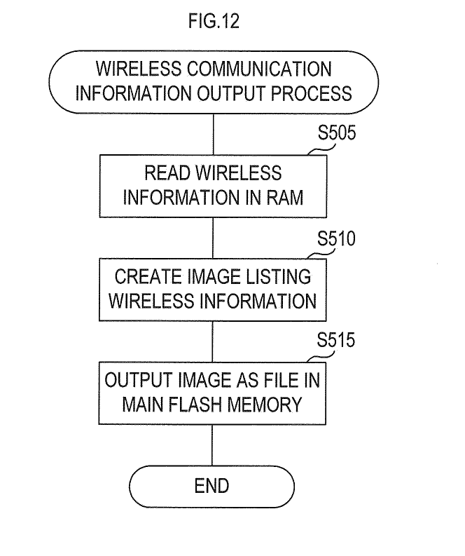

Described next is wireless communication information output process with reference to the flowchart in FIG. 12. The execution of this wireless communication information output process is initiated, for example, (a) when electric supply from the another device 20 is started with the storage device 10 inserted into the slot of the another device 20, (b) when a button (not shown in FIG. 1) provided at the storage device 10 is pressed down, (c) when the CPU 14 detects a predetermined command transmitted from the another device 20 to the storage device 10, or the like.

When the execution of the wireless communication information output process is initiated, the CPU 14 allows the RAM 16 to load wireless information stored in the sub flash memory 15 (S505). This wireless information is information used by the wireless LAN controller 17 for wireless communication and is, specifically for example, an SSID, a password, an encryption method, an IP address obtaining method, a server name of an access point, a login name to a server, a login password to a server, or the like.

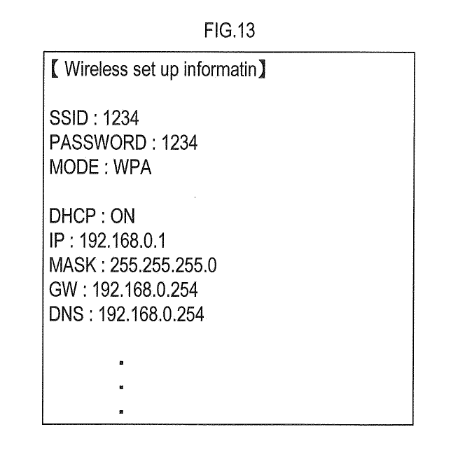

The CPU 14 then creates a wireless information image in which the wireless information loaded to the RAM 16 is listed up (S510). As the wireless information image, an image illustrated in FIG. 13 is conceivable, for example. That is, a plurality of lines, each of the lines having a set of an item name and a setting content regarding wireless setting, are indicated in the image. A text listing the wireless information may be employed instead of the wireless information image.

The explanation goes back to the flowchart in FIG. 12. The CPU 14 then stores the created wireless information image in the main flash memory 11 as a wireless information still image file (S515), and terminates the subject process (wireless communication information output process).

[Effects]

In a case where the first still image handling process is executed, when a still image file is transmitted from the another device 20, the above mentioned storage device 10 synthesizes predetermined advertising information to the still image file inside the storage device 10 and stores, in the main flash memory 11, as a synthesized still image file (S330, S335). Therefore, even if the storage device 10 is separated from the another device 20 and kept being distributed, there are synthesized still image files stored inside the storage device 10. Therefore, if the synthesized still image files stored are browsed, advertising information catches the users' attentions. That is, comparing with the case where advertising information is synthesized only when a still image is displayed inside the another device 20, the use of the storage device 10 can make advertising accessible to more people.

Further, in a case where the first still image handling process is executed, the CPU 14 of the storage device 10 does not synthesize advertising information to a still image file newly written within ten seconds from the last storing of a file in the main flash memory 11 (S305; Yes). Therefore, for example when a plurality of still image files are written in the storage device 10 within a predetermined period of time, regarding a still image file written first, a synthesized still image file synthesized with a predetermined information is created and stored, but, regarding a still image file written secondly or after, a synthesized still image file is not created. That is, the users can avoid synthesizing intentionally by controlling a timing to write the still image file, which leads to a user-friendly storage device.

Still further, in a case where the first still image handling process is executed, the CPU 14 of the storage device 10 analyzes a still image file transmitted from the another device 20 (S320). When a human face is included in the still image, the CPU 14 synthesizes advertising information at a location other than the face (or the entire human body), so that a synthesized still image is created (S330). Therefore, it is possible to avoid creating a synthesized still image file of the still image in which the advertising information overlaps the human face, thereby enabling reducing unpleasantness of users relating synthesizing of the advertising information.

Still further, in a case where the first still image handling process is executed, the CPU 14 of the storage device 10 analyzes a shooting location of a still image file transmitted from the another device 20 (S320), and selects, from among a plurality of synthetic data files stored in the sub flash memory 15, a synthetic data file which displays advertising information relating to the location (S325). Therefore, a synthesized still image file of a still image synthesized with information corresponding to the shooting location of the still image file is created, thereby enabling to enhance advertising effects.

In a case where the first moving image handling process is executed, when a moving image file is transmitted from the another device 20, the CPU 14 of the storage device 10 synthesizes predetermined advertising information to the moving image file inside the storage device 10 and stores in the main flash memory 11 as a synthesized moving image file (S420, S425). Therefore, even if the storage device 10 is separated from the another device 20 and kept being distributed, there are synthesized moving image files stored inside the storage device 10. Therefore, if the synthesized still image files stored and browsed, advertising information catches the users' attentions. That is, comparing with the case where advertising information is displayed only when a moving image is displayed inside the another device 20, the use of the storage device 10 can make advertising accessible to more people.

In a case where the second moving image handling process is executed, when a moving image file is transmitted from the another device 20, the CPU 14 of the storage device 10 combines a moving image including predetermined advertising information to the moving image file inside the storage device 10 and stores in the main flash memory 11 as a combined moving image file (S465). Therefore, even if the storage device 10 is separated from the another device 20 and kept being distributed, there are combined moving image files stored inside the storage device 10. Therefore, if the combined moving image files stored are browsed, advertising information catch the users' attentions. That is, comparing with the case where advertising information is displayed only when a moving image is displayed inside the another device 20, the use of the storage device 10 can make advertising accessible to more people.

In a case where executing the first still image handling process or the first and second moving image handling processes, the CPU 14 of the storage device 10 stores, in the main flash memory 11, an original file with a different file name in the same condition as it was (S310, S375, S405, S455). Therefore, users can obtain the original file when needed, thereby making the storage device 10 useful.

In a case where executing the second still image handling process, when the still image files are sent from the another device 20, the CPU 14 of the storage device 10 stores an additional still image file in the main flash memory 11 every tenth file (S355, 375). Therefore, even if the storage device 10 is separated from the another device 20 and kept being distributed, there is an additional still image file stored inside the storage device 10. Therefore, if the additional still image file stored is browsed, advertising information catches the users' attentions. That is, comparing with the case where advertising information is synthesized only when a still image is displayed inside the another device 20, the use of the storage device 10 makes advertising accessible to more people.

In a case where executing the second still image handling process, when the CPU 14 of the storage device 10 stores an additional still image file in the main flash memory 11, the CPU 14 uses a file name changed by increasing, by one, the number portion of a file name of the still image file stored in the main flash memory (S365, S375). Therefore, when the files stored in the storage device 10 are arranged on the PC etc. in ascending order of the file name, each of the additional still image files is arranged between the original still image files. Therefore, advertising effects are enhanced when the users browse the files in the order of the file name.

Further, when the CPU 14 of the storage device 10 determines that the cancel condition is satisfied (the adding of advertisement is cancelled) during the first and second cancel condition determining processes, addition of advertisement (the first and second still image handling processes, and the first and second moving image handling processes) is no longer executed thereafter. Therefore, it can deal with users not desiring the addition of advertisement, and the users can be motivated to act to satisfy the cancel condition.

In a case where the first cancel condition determining process is executed, when a condition, in which the number of executing the still image handling process or the moving image handling process reaches the predetermined number of times, is satisfied, the CPU 14 of the storage device 10 no longer executes adding of advertisement. Therefore, after satisfying the condition, it is possible to use the storage device 10 as a storage medium which does not execute the adding of advertisement to the still image file or the moving image file. Therefore, it is possible to encourage more users to use the storage device 10 before canceling, thereby enabling to enhance advertising effects.

In a case where executing the second cancel condition determining process, when a condition, in which a still image file that can display a still image including the predetermined image for determination is written in the main flash memory 11, is satisfied, the CPU 14 of the storage device 10 no longer executes adding of advertisement to the still image file thereafter. Therefore, after satisfying the condition, it is possible to use the storage device 10 as a storage medium which does not execute adding of advertisement to the still image file. Therefore, it is possible to encourage more users to use the storage device 10 before canceling, thereby enabling to enhance advertising effects.

The additional still image file when executing the second cancel condition determining process is the one partially having a URL to access websites that can browse the predetermined image for determination. Since the users do not wish advertisement addition to be performed, they are very conscious of additional still image files. Therefore, a corporation, which distributes the storage device 10, can effectively advertise on the website of which URL is included in the additional still image file.

Further, the CPU 14 of the storage device 10 executes the wireless communication information output process so as to create a wireless information image and to store as a wireless information still image file in the main flash memory 11 (S505-S515). Therefore, users use a PC or the like that can be connected to the storage device 10 and confirm the wireless information still image file stored in the main flash memory 11 of the storage device 10. Therefore, the users can confirm wireless information upon communicating with an external server via the wireless LAN controller 17. That is, it is possible to confirm the wireless information by use of commonly sold devices not by use of exclusive software.

### Other Embodiments

### (1) Other Embodiment 1

During the above-described first file writing process, the cancel condition determining process is executed (S110) following the step (S105) in which the file sent from the another device 20 is written in the main flash memory 11. However, the operations after the cancel condition determining process (S115-S135) can be executed at different timings. This is because, for example when a plurality of files are sent successively from the another device 20 to the storage device 10, the memory controller 12 is likely to engage exclusively in a process for writing the files in the main flash memory 11, and hardware resources is not likely to be able to be devoted to writings to the main flash memory 11 or the like, which arise in the operations after the cancel condition determining process (S115-S135).

Therefore, it is conceivable that the CPU 14 executes the processes after the cancel condition determining process (S115-S135), for example, at a timing when a group of consecutive and plural files sent from the another device 20 has been all written in the main flash memory 11.

The operation to write, in the main flash memory 11, the file sent from the another device 20 (S105) responds to a command sent from the another device 20. However, the operations after the cancel condition determining process (S115-S135) may be executed at a predetermined cycle (e.g., ten seconds, one minute) and independently from that. Also, when the operations after the cancel condition determining process (S115-S135) is initiated, it is preferable to first check the presence or absence of a file newly stored in the main flash memory 11 after the previous checking. Further, it is preferable to execute the operations after the cancel condition determining process (S115-S135) relative to the file newly stored after the previous checking, based upon the check result.

Further, it is conceivable for the storage device 10 to be provided with two memory controllers 12. In this case, one of the two memory controllers 12 is assigned with the step (S105) to write, in the main flash memory 11, a file sent from the another device 20, and the other one thereof is assigned with the steps after the cancel condition determining process (S115-S135).

Also, if the memory controller 12 can time-share multiple operations and process the same simultaneously in a pseudo-manner, the memory controller 12 may perform, in parallel, the processes (S115-S135) that arise after the cancel condition determining process, such as writing to the main flash memory 11, to the files sent from the another device 20 in series starting from a file to which the process for writing the file in the main flash memory 11 (S105) has been completely performed.

In any cases, it is needless to say that the CPU 14 operates based upon programs so that the purposes of, the cancel conditions of the still image handling process and the cancel condition determining process (S160, S175, S215), the condition of a time interval to store the file in the main flash memory 11 (S305), and the condition related to the frequency to add the additional still image file (S355) are achieved in the same manner.

### (2) Other Embodiment 2

At the above described first moving image handling process, the advertising information based upon the synthetic data file is synthesized to the first ten seconds of the moving image sent from the another device 20 (S420). However, it is not limited to the first ten seconds of the moving image, and the last ten seconds, the middle (e.g., a portion where the scene is switched), or the like may be employed. Even this type of storage device 10 can exhibit the same effects as the above-described first embodiment.

### (3) Other Embodiment 3

According to the above embodiments, the synthetic data file, the combining moving image file, and the additional still image file can be stored in the sub flash memory 15 at a time of manufacturing, shipping, selling the storage device 10, or the like, but they do not have to be so. The CPU 14 may obtain these files from an external server via the wireless LAN controller 17 and the antenna 18 and may newly store the same in the sub flash memory 15. According to this type of storage device 10, even after the storage device 10 has been delivered to a user, it is possible to update each of the files, thereby enabling to inhibit old advertisements from being synthesized as much as possible and enhancing advertising effects.

### (4) Other Embodiment 4

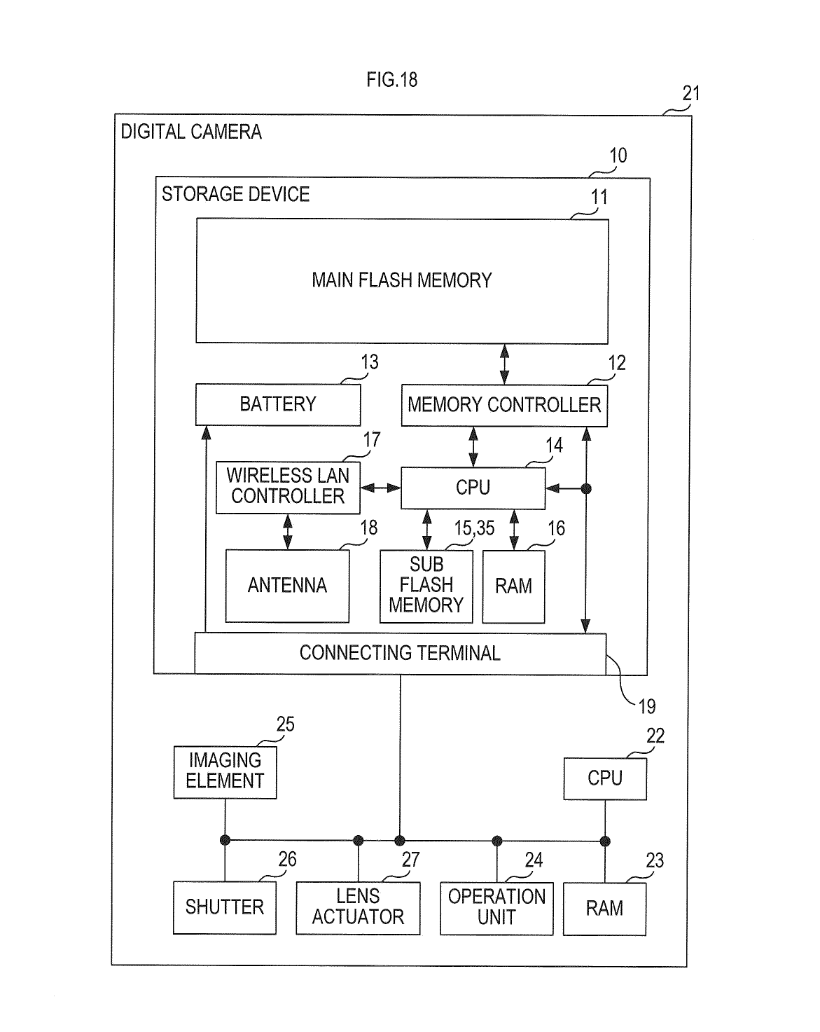

The above described another device 20 may be a digital camera. Also, the storage device 10 may be fitted into a housing of the digital camera in a detachable or non-detachable manner. That is, the above-described another device 20 and storage device 10 may be configured as a digital camera 21, as illustrated in FIG. 18.

The digital camera 21 is provided with the structure of the above-described storage device 10 and is further provided with a CPU 22, a RAM 23, an operation unit 24, an imaging element 25, a shutter 26, and a lens actuator 27.

The CPU 22 brings the digital camera 21 into focus on an object to be image-captured by controlling the lens actuator 27 based upon the operation command from the operation unit 24, operates the shutter 26, and exposes the imaging element 25 to light. Further, the CPU 22 holds, in the RAM 23, image information outputted by the imaging element 25 and constitutes a JPEG file and so on. The CPU 22 then transmits the constituted file to the storage device 10.

According to this type of digital camera 21, the above-described effectiveness can be increased.

### (5) Other Embodiment 5

According to the above embodiment, the main flash memory 11 and the sub flash memory 15 are provided separately, but both may be implemented as a single hardware. Specifically, the sub flash memory 15 may be removed from the storage device 10, and a partial area of the main flash memory 11 may be assigned as an area corresponding to the sub flash memory 15. In this type of configuration, it is preferable that the CPU 14 or the memory controller 12 operates so as not to allow an access from the another device 20 to the partial area of the main flash memory 11 corresponding to the sub flash memory 15 unless the access from the another device 20 is a specific access method (for example, a method using an exclusive application).

[Correspondence Between the Terms Used to Describe the First Embodiment and the Terms Used in the Scope of Claims]

The main flash memory 11 is an example of a first storing device, the sub flash memory 15 is an example of a second storing device, and the CPU 14 is an example of a control device, a synthetic data file storing control device, a combining moving image file storing control device, an additional still image file storing control device, and an information outputting device.

Further, the wireless LAN controller 17 and the antenna 18 are an example of a wireless communicating device, each of the still image handling process and the moving image handling process is an example of a data process, and S215 of the second cancel condition determining process is an example of a determination process.

### Second Embodiment

Described below is a second embodiment.

[Description of the Structure]

The structure of a storage device 30 of the second embodiment is substantially identical with the one of the storage device 10 of the first embodiment described above. The same structures as the ones of the first embodiment are identified by the same reference numerals and explanation thereof will be omitted (see FIG. 1). Programs stored in a sub flash memory 35 of the storage device 30 of the second embodiment are different from the ones stored in the sub flash memory 15 of the storage device 10 of the first embodiment. Therefore, processes executed by the CPU 14 of the storage device 30 of the second embodiment are different from the ones executed by the CPU 14 of the storage device 10 of the first embodiment.

[Description of Operation]

Described below is an operation of the storage device 10 of the second embodiment.

(1) Second File Writing Process

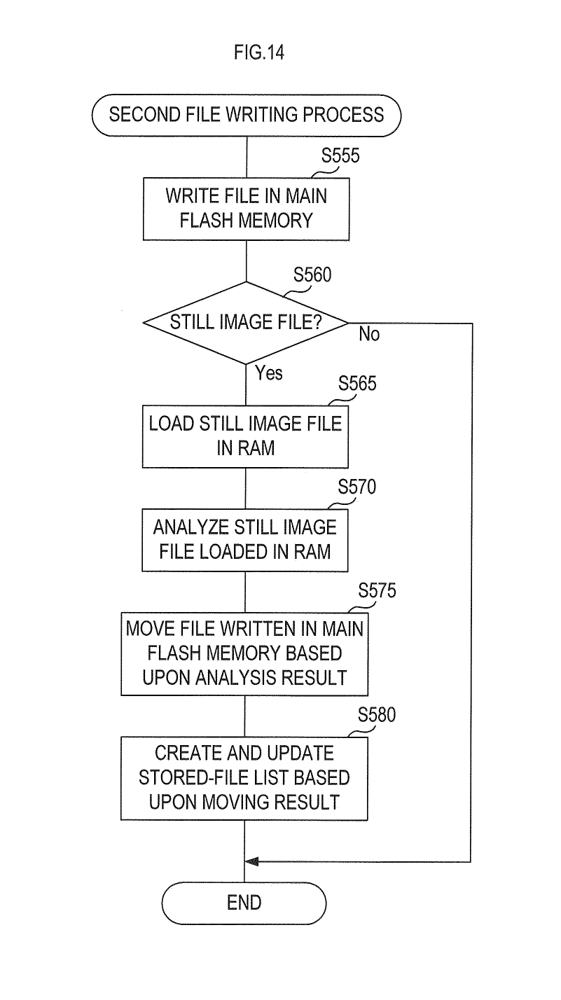

The second file writing process will be described with reference to the flowchart in FIG. 14. The execution of this second file writing process is initiated when the CPU 14 receives, from the another device 20, a signal denoting that a file is sent from the another device 20, in a state where the connecting terminal 19 of the storage device 30 is connected to the connecting terminal provided at the slot of the another device 20.

When the CPU 14 of the storage device 30 receives a signal denoting that a file is sent from the another device 20, the CPU 14 instructs the memory controller 12 so as to write, in the main flash memory 11, the file sent from the another device 20 (S555). The memory controller 12 received the instructions writes sequentially, in a free space of the main flash memory 11, file data sent from the another device 20 via the connecting terminal 19. When a data denoting the end of the subject files is sent from the another device 20, the memory controller 12 returns to the CPU 14 that the file writing has completed.

Following that, the CPU 14 determines whether or not the file written in the main flash memory 11 at S555 is a still image file (S560). As a determining method, determination based upon an extension of the file, determination by allowing the RAM 16 to read a part of the file, such as a header, and so on are conceivable, but the determining method is not limited to the above.

When the determination result at S560 is affirmative, i.e., when the file written in the main flash memory 11 at S555 is a still image file (S560: Yes), the CPU 14 proceeds with the process to S565. Meanwhile, when the determination result at S560 is negative, i.e., when the file written in the main flash memory 11 at S555 is not a still image file (S560: No), the CPU 14 terminates the subject process (second file writing process).

At S565 to which the process proceeds when the determination result at S560 is affirmative, the CPU 14 allows the RAM 16 to load the still image file written in the main flash memory 11 at S555.

Next, the CPU 14 analyzes the still image file loaded to the RAM 16 (S570). Analyzing mentioned here is as follows for example. (a) determination is made as to whether or not a human face is included in a still image based upon the still image file. When the human face is included in the still image, identification is made as to the position, and the size, of the human in the still image. And, identification is made as to who the human included in the still image is, with reference to data on human features pre-stored in the sub flash memory 15 or data on human features stored in an external database connectable via the wireless LAN controller 17. (b) identification is made as to what an object included in the still image is (for example, a mountain, a bridge, an ocean, an automobile, a train, an airplane, a ship, furniture, an animal, or the like). (c) identification is made as to a shooting location of the still image, with reference to geotags included in the still image file. (d) identification is made as to the shooting date and time of the still image.

Next, the CPU 14 moves, based upon the analyzing result, the still image file written in the main flash memory 11 at S555 to any one of the folders in the main flash memory 11 (S575). Specifically, for example, when a human is identified, the still image file is moved to a folder that is provided every corresponding human and corresponds to the main person included in the still image (the main person obtained based upon the determination result of the positions, and the sizes, of the faces in the still image). When an object is identified, the still image is moved to a folder that is provided every corresponding object and corresponds to the object included in the still image. When the shooting location is identified, the still image is moved to a folder that is provided per shooting location and corresponds to the shooting location of the still image. When the shooting date and time is identified, the still image is moved to a folder that is provided per date and time (e.g., 1 pm, 2 pm, 3 pm, . . . of April 1) and corresponds to the shooting date and time of the still image. It is needless to say that per date can be used in place of per date and time. When these exemplified folders do not exist in the main flash memory 11, it is needless to say to create new folders.

Next, the CPU 14 creates a stored-file list in the main flash memory 11 or updates the stored-file list stored in the main flash memory 11, based upon the moving result of the still image file at S575 (S580). The stored-file list mentioned here is a list of pairs, each pair consisting of a file name and its thumbnail image of the still image file stored in the main flash memory 11. Further, the pairs are divided according to respective storage folders in the list. If there is neither a stored-file list created nor present in the main flash memory 11, a stored-file list is newly created in the main flash memory 11. When there is a stored-file list already present in the main flash memory 11, the stored-file list is updated.

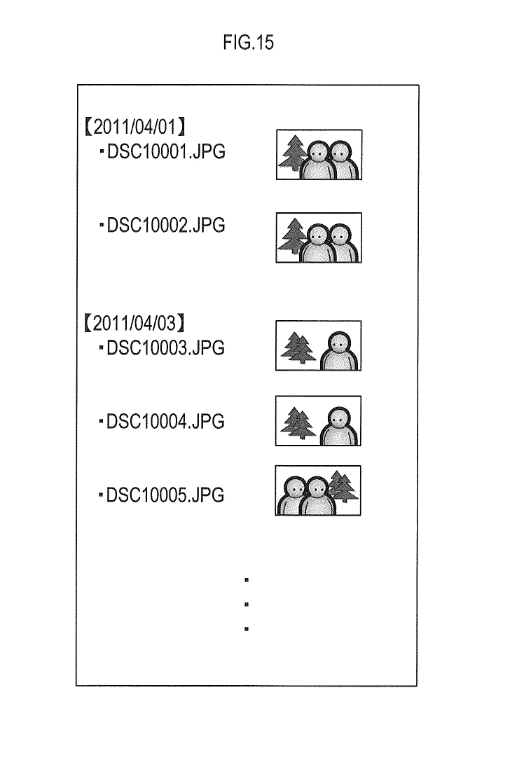

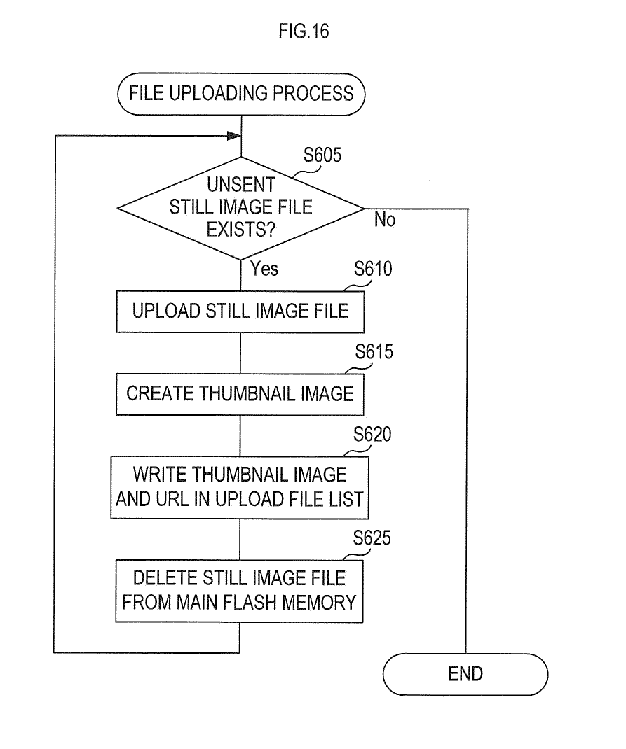

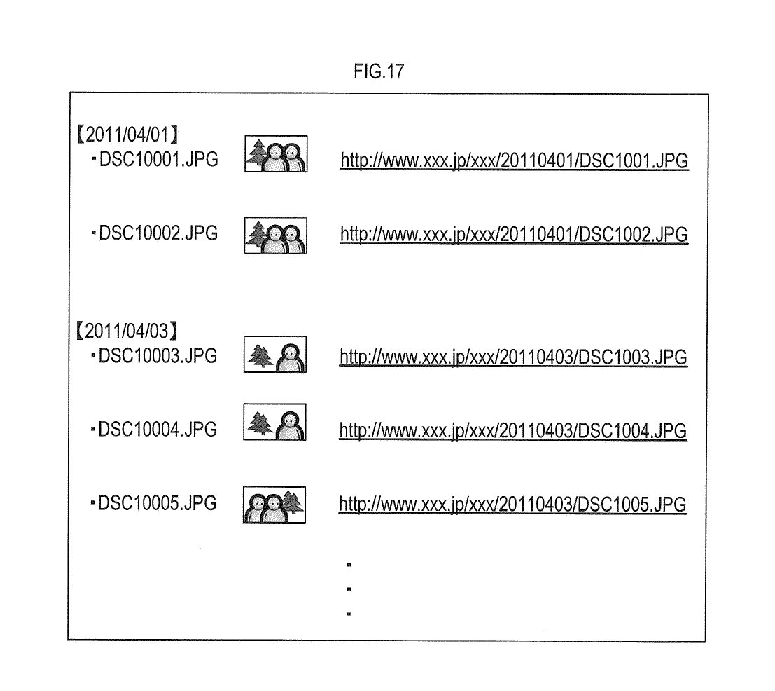

Here, an example of the stored-file list will be explained here with reference to FIG. 15. The stored-file list shown in FIG. 15 is a list in which plural pairs, each pair consisting of the file name (DSC1001.JPG etc.) and its thumbnail image, are organized and listed per folder (2011, 4 Jan. etc.).

Bringing back the explanation to FIG. 14, when S580 is ended, the CPU 14 terminates the subject process (second file writing process).

(2) File Uploading Process

Described below is a file uploading process with reference to the flowchart in FIG. 16. The execution of this file uploading process is initiated repetitively by a predetermined time interval in a state where the connecting terminal 19 of the storage device 30 is connected to the connecting terminal at a slot of the another device 20 (in a state where electric power is supplied from the another device 20 to the storage device 30). As the predetermined time interval mentioned here, a time interval, such as one minute or ten minutes, is conceivable.

When the execution of the file uploading process is initiated, the CPU 14 firstly determines whether or not there is at least one still image file stored in the main flash memory 11, which has not been sent to a server (S605). The server mentioned here is a server that is able to communicate via the wireless LAN controller 17 and the antenna 18. The server is able to receive and store etc. the still image file. The determination as to whether or not it has not been sent is performed for example based upon an archive attribute of each still image file or based upon a management file separately provided in the main flash memory 11.

When a determination result at S605 is affirmative, i.e., when there is at least one still image file stored in the main flash memory 11, which has not been sent to the server (S605: Yes), the CPU 14 proceeds with the process to S610. Meanwhile, when the determination result at S605 is negative, i.e., when there is no still image file stored in the main flash memory 11, which has not been sent to the server (S605: No), the CPU 14 terminates the subject process (file uploading process).

At S610 to which the process proceeds when the determination result at S605 is affirmative, the CPU 14 selects one still image file that has not been sent to the server. The CPU 14 then reads, from the main flash memory 11, the still image file selected and transmits the same to the server via the wireless LAN controller 17 and the antenna 18.

Next, the CPU 14 creates a thumbnail image to be displayed based upon the still image file sent at S610 (S615).

Next, the CPU 14 adds, to an upload file list stored in the main flash memory 11, the thumbnail image created at S615 and an URL to which the still image file transmitted at S610 is downloadable (S620). When there is no upload file list present in the main flash memory 11, an upload file list is newly created and written.

Described below is an example of the upload file list with reference to FIG. 17. The upload file list shown in FIG. 17 is a list in which a plurality of groups, each group consisting of a file name (DSC1001.JPG etc.), its thumbnail image, and a URL to which the still image file is downloadable from the server, are organized and listed per folder (2011, 4 Jan. etc.). Also, the information size of each group (the storage capacity consumed in the main flash memory 11) is significantly smaller than the one of the corresponding still image file.

Bringing back the explanation to the flowchart in

FIG. 16, the CPU 14 deletes, from the main flash memory 11, the still image file transmitted at S610 (S625) and returns the process back to the above-described S605.

[Effects]

The CPU 14 of the above-described storage device 30 classifies the still image file sent from the another device 20 based upon predetermined features of the still image file (S575). Specifically, the CPU 14 moves the still image file to the corresponding folder, based upon the presence or absence of a specific object included in the still image, the shooting time and date of the still image file, the shooting location of the still image file, or the like. Therefore, when there is nothing wrong with the classification (the moving results of the file) from the user's view, there is no need for the user to perform classification (file moving). Meanwhile, when the classification (file moving) is partially not correct from the user's view, classification (file moving) may be performed manually on only the incorrect file on PC and so on. Therefore, its usability will be significantly enhanced than before. Also, since it is possible to read out the still image files, which belong to a specified classification, in a lump every folder, it is convenient.

Further, the CPU 14 of the storage device 30 creates a stored-file list in the main flash memory 11 or update the stored-file list stored in the main flash memory 11, based upon the moving result after moving the still image file (S580). Therefore, users can easily recognize the content of the still image file allocated in each folder by using the stored-file list (e.g., the list shown in FIG. 15).

Regarding a still image file, which is one of the still image files stored in the main flash memory 11 but has not been sent to an external server yet, the CPU 14 of the storage device 30 creates a thumbnail image of a still image displayed by the still image file and then adds, in the upload file list in the main flash memory 11, the thumbnail image as well as an URL which can obtain the sent still image file from the server (S615, S620). After this, the CPU 14 deletes the still image file from the main flash memory 11 (S625).

Therefore, even after deleting the still image file from the main flash memory 11, by connecting the storage device 30 to a device such as PC, users can refer, on the device, to a thumbnail image and an URL which can obtain the still image file from the server. That is, even after the transmission of the still image file to the server and the deletion of the same, users can know, using the thumbnail images or URLs as clues, which still image files had been stored in the storage device 30, where the users had better access to obtain, and the like. Therefore, the still image files transmitted to the server can be used more effectively.

### [Other Embodiments]

### (1) Other Embodiment 1

According to the above embodiment, in the file uploading process, a still image file stored in the main flash memory 11 is transmitted to a server (S610), and after that, a thumbnail image is created (S625), and the thumbnail image and so on is additionally written in the upload file list (S620). However the order is not limited to the above. For example, the still image file stored in the main flash memory 11 may be transmitted to the server after creating the thumbnail image and additionally writing the thumbnail image and so on in the upload file list. Even by this, the same effects as the above embodiment are exhibited.

### Other Embodiment 2

According to the above embodiment, at the file uploading process, the still image file is deleted from the main flash memory 11 (S625), but the deleting timing is not limited to the above. For example, the still image file in the main flash memory 11, which has been transmitted to the server, may be marked. At a timing when an amount of free space of the main flash memory 11 falls below a predetermined amount, the still image file with the mark may be deleted from the main flash memory 11. Even by this, the same effects as the above embodiment are exhibited.

[Correspondence Between the Terms Used to Explain the Second Embodiment and the Terms Used for the Claims]S565 to S575 of the second file writing process is an example of a classifying process, and S580 of the second file writing process is an example of a listing process.

1-29. (canceled)

30. A storage device comprising:
a connecting terminal that communicates data with an another device;
a first storing device that is able to store a still image file received from the another device via the connecting terminal;
a second storing device that stores a synthetic data file used when synthesizing a predetermined information to a still image; and
a control device that executes a data process when the still image file is stored in the first storing device, the data process being a process in which a synthesized still image file is created that is able to display a still image, in which the predetermined information based upon the synthetic data file stored in the second storing device is synthesized to a portion of the still image displayed by the still image file, and the synthesized still image file is stored in the first storing device.

31. The storage device according to claim 30, wherein, even if the still image file is stored in the first storing device, the control device does not execute the data process when a time elapsed after immediately last storing of a different still image file in the first storing device is within a predetermined period of time.

32. The storage device according to claim 30, wherein, when the still image file stored in the first storing device is a file able to display an image containing a human face, the control device synthesizes, in the data process, the predetermined information at a location other than the human face.

33. The storage device according to claim 30, wherein a plurality of the synthetic data files are stored in the second storing device, and the control device selects the synthetic data file from the second storing device based upon a shooting location of the still image displayed by the still image file stored in the first storing device and executes the data process by use of the synthetic data file selected.

34. The storage device according to claim 30 further comprising:
a synthetic data file obtaining device that obtains the synthetic data file from the another device; and
a synthetic data file storing control device that replaces the synthetic data file stored in the second storing device with the synthetic data file obtained from the another device via the synthetic data file obtaining device and stores the synthetic data file obtained from the another device via the synthetic data file obtaining device.

35. The storage device according to claim 30, wherein, when a predetermined cancel condition is satisfied, the control device no longer executes the data process thereafter.

36. The storage device according to claim 35, wherein the cancel condition is a condition that a number of times to have performed the data process reaches a predetermined number of times.

37. The storage device according to claim 35, wherein, when the still image file that can display the still image is written in the first storing device, the control device executes a determination process to determine whether or not the still image file is for displaying an image containing a predetermined determination image, and the cancel condition is a condition that an affirmative determination is made at the determination process.

38. The storage device according to claim 30, wherein the another device is a device provided with an imaging element, image information obtained from the imaging element is stored as a file in the first storing device, and the storage device is connected to the another device via the connecting terminal and is arranged with the another device in the same housing.

39. A non-transitory computer-readable storage medium that stores a program that makes a computer function as the control device according to claim 30.

40. A storage device comprising:
a connecting terminal that communicates data with an another device;
a first storing device that is able to store a still image file received from the another device via the connecting terminal;
a second storing device that stores an additional still image file able to display a still image containing a predetermined information; and
a control device that executes a data process when a predetermined number of still image files is stored in the first storing device, the data process being a process in which the additional still image file stored in the second storing device is stored in the first storing device.

41. The storage device according to claim 40, wherein a plurality of still image files received in order from the another device via the connecting terminal have respectively file names containing numbers not overlapping each other and in ascending sequence, and the control device stores, in the first storing device, the additional still image file with a file name having a number portion incremented by one from the number portion of a file name of a still image file received last among the predetermined number of still image files and stored in the first storing device.

42. The storage device according to claim 40 further comprising:
an additional still image file obtaining device that is able to obtain the additional still image file from the another device; and
an additional still image file storing control device that replaces the additional still image file stored in the second storing device with the additional still image file obtained from the another device via the additional still image file obtaining device and stores the additional still image file obtained from the another device via the additional still image file obtaining device.

43. A storage device comprising:
a connecting terminal that communicates data with an another device;
a first storing device that is able to store a still image file received from the another device via the connecting terminal; and
a control device that performs a classifying process to classify the still image file stored in the first storing device based upon a predetermined feature of the still image file.

44. The storage device according to claim 43, wherein the control device performs the classifying process based upon at least any one of presence or absence of a specific object included in a still image displayed by the still image file, a shooting time and date of the still image file, and a shooting location of the still image file.

45. The storage device according to claim 43, wherein, in the classifying process, the control device classifies the still image file by moving the still image file to a folder of each classification.

46. The storage device according to claim 43, wherein the control device further performs a listing process, in which a list of the still image file classified based upon the classifying process is created and stored in the first storing device, the list having information arranged by each classification thereon, the information being able to identify the still image file.
